(19) United States
(12) Patent Application Publication
(10) Pub. No.: US 2025/0258470 A1
(43) Pub. Date: Aug. 14, 2025

(54) SYSTEMS AND METHODS FOR ENERGY DISTRIBUTION CONTROL USING A DISTRIBUTED ENERGY RESOURCE MANAGEMENT SYSTEM

(71) Applicant: Vivint LLC, Provo, UT (US)

(72) Inventors: Tracy Alexander, Provo, UT (US); JP Dowling, Provo, UT (US); Michael D. Child, Provo, UT (US); Candy Wong, Provo, UT (US)

(73) Assignee: Vivint LLC, Provo, UT (US)

(21) Appl. No.: 19/049,854

(22) Filed: Feb. 10, 2025

Related U.S. Application Data
(60) Provisional application No. 63/552,051, filed on Feb. 9, 2024.

(51) Int. Cl. G05B 19/042

(52) U.S. Cl. CPC G05B 19/042; G05B 2219/2639

(57) ABSTRACT

The systems and methods provide techniques for a distributed energy resource management system (DERMS). The system can optimize energy distribution by leveraging Distributed Energy Resources (DERs) (such as thermostats for HVAC systems, electric vehicle (EV) chargers, and home battery storage) by shifting energy among devices and home. During peak demand, the VPP can minimize the cost to the company, reduce demand on the grid, and ultimately reduce long-term consumer costs. The system can utilize home sensors to determine a state of occupancy (such as a home is occupied, unoccupied, or the residents are on vacation). The system can consider a desired comfort level. The various sources of data (e.g., energy data, cost data, and home sensor data) can be used to manage energy distribution in a VPP and generate demand response events or other instructions for energy usage based on real-time occupancy data.

### CROSS REFERENCE

This application claims priority to United States Provisional Patent Application, 63/552,051, filed Feb. 9, 2024, and entitled SYSTEMS AND METHODS FOR ENERGY DISTRIBUTION CONTROL USING A DISTRIBUTED ENERGY RESOURCE MANAGEMENT SYSTEM, which is incorporated by reference herein in its entirety.

### TECHNICAL FIELD

This application generally relates to the field of energy management systems, particularly to the optimization and control of distributed energy resources using a distributed energy resource management system.

### BACKGROUND

Traditional energy systems are often challenged by the intermittent nature of renewable energy sources and the fluctuating demand patterns of consumers. Distributed energy resources (DERs) are small-scale electricity supply or demand resources that are coupled to the electric grid. DERs can be situated near sites of electricity use, such as rooftop solar panels, battery storage and electric vehicles. The concept of virtual power plants (VPPs) has been proposed and used as a solution for assuring an affordable, secure, and steady supply of energy through a smart grid.

### SUMMARY

The systems and methods provide techniques for using a distributed energy resource management system (DERMS) to control a virtual power plant (VPP) or otherwise control energy resources. The DERMS can optimize energy distribution from different DERs located in different structures. Examples of such DERs can include, but are not limited to, thermostats for HVAC systems, electric vehicle (EV) chargers, energy storage systems (ESSs), and home battery storage. The DERMS can manage DERs by shifting or reducing energy use among devices and homes. During peak demand, the VPP can minimize the cost to procure power for the structure, reduce demand on the grid, and ultimately reduce long-term consumer costs. The system can utilize home sensors to determine a state of occupancy (such as a home is occupied, unoccupied, or the residents are on vacation). The system can also consider a desired comfort level, including how long it may take to reach a desired temperature using an HVAC system. The various sources of data (e.g., energy data, cost data, and home sensor data) can be used to manage energy distribution in a VPP and generate demand response events or other instructions for energy usage based on real-time occupancy data.

In a demand response event, the system can instruct a thermostat or other DERs. For example, in one configuration, using direct load control, the system can reduce customer demand by controlling energy-consuming appliances during the period in which the thermostat is controlled. In another configuration using a behavioral demand response, customers can actively participate to lower their demand. The demand response event can allow for peak shaving whereby users can voluntarily reduce energy use during peak consumption periods. The demand response event can reduce energy used of various DERs, such as thermostats, smart building energy management controls, HVAC systems, water heaters, backup generators, refrigerators, ice makers, elevators, and other appliances. In addition to energy pricing and/or availability of energy, the systems and methods described below can generate a demand response event or cause other adjustment of energy consumption based in part on occupancy, energy efficiency, and/or comfort within a structure.

The systems and methods described herein allow for various new functionality of a DERMS. In one aspect, one or more processors (e.g., one or more processors of a DERMS) can be configured by computer-readable instruction to determine a need for a change in energy consumption at one or more structures based upon energy pricing or energy availability data; responsive to detecting the increase in energy pricing or the decrease in energy capacity, execute an occupancy model configured to receive sensor data from a structure of the one or more structures and output a state of occupancy for the structure; generate a demand response event instruction indicating an energy adjustment for at least one distributed energy resource (DER) of the structure based at least on the state of occupancy for the structure; and transmit the demand response event instruction to the structure.

In one aspect, a DERMS can be used in orchestration of a VPP dispatch. A decision-making tool for orchestrating a demand response event dispatched by a DERMS can select participating homes/buildings, dispatchable devices, and/or a set of devices to participate in based on some or all of the factors described herein. Priorities for dispatch can be based on energy efficiency, energy use at peak times, and customer comfort.

Orchestration factors may include geographic location/region, expected/current price of electricity in a geographical region/load zone, an energy/utility subscription plan for a structure, HVAC attributes (e.g., duty cycle and efficiency, time to return to desired temperature, whether current temperature is above/below the desired temperature and the demand response temperature), smart home data (e.g., is the structure occupied, how long will it be occupied or unoccupied), battery (e.g., predicted schedule of use, amount to draw down, level of charge needed to participate, planned leave time, predicted/expressed usage schedule, predicted/expressed charging schedule), generator (e.g., when available for use, when noise will be a factor, fuel level), user comfort tolerance, and/or allowing users to opt-in to different levels of participation (e.g., thermostat can be adjusted 1, 2, or 3 degrees).

In another aspect, each structure (e.g., home or building) can receive individualized, demand response event-specific VPP dispatch instructions for that structure during a specific demand response event based on some or all of the factors. For example, if a home is unoccupied, the dispatch instructions can create a bigger adjustment to dispatchable energy consuming devices in the home. Additionally, structures with efficient HVAC systems may be preconditioned (pre-cooled/heated).

In another aspect, a DERMS decision-making tool can select a subset of enrolled subscribers to participate in a demand response event based on some or all of the factors.

In another aspect, a scalable VPP dispatch schedule can be orchestrated with levels of severity for a single potential demand response event, which can be adjusted as needed.

In another aspect, the system can predict the power savings available for a demand response event at a particular day/time period based on some or all of the factors and a desired optimization of the priorities.

In another aspect, the system can customize a VPP dispatch schedule based on an input of needed energy savings. For example, a computing device can request an energy quantity and region, and the system calculates the orchestration required to meet that request.

In another aspect, the system can orchestrate the severity of a dispatch based on the cost of power based on some or all of the factors.

In another aspect, a method of assessing/calculating a customer's comfort preferences based on the following data collected from an HVAC smart thermostat: (i) user opt-out history, (ii) user tolerance before they opt out, (iii) how long before they opt out and/or (iv) what temperature change before the user opts out.

In another aspect, determining an HVAC system's usefulness for VPP dispatch can compare the following to similar data from other HVAC systems: (i) HVAC duty cycles/run times to see how efficient they are at lowering the temperature of a home, (ii) how often an HVAC is on during an hour, and (iii) how fast the HVAC can get the structure/home back to the right temperature.

In another aspect, a decision-making tool for orchestrating a DR event dispatched by a DERMS can select participating structures based on occupancy information made using real-time sensor data.

In one embodiment, a system may comprise a computing device configured to: determine a need for a virtual power plant based upon energy pricing or energy availability data; and generate a request for an energy adjustment based on the need; at least one server configured to execute an occupancy model configured to receive sensor data from a structure and output a state of occupancy for the structure, the server comprising an automation application configured to receive the request from the computing device and generate and transmit an instruction for the energy adjustment for at least one distributed energy resource (DER) of the structure; and a distributed energy resource management system (DERMS) configured to receive a status from each DER, receive the instruction from the automation application, and transmit the instruction to at least one DER.

The at least one server may be further configured to execute a comfort level model configured to measure a variation of operation of the at least one DER from a user's setting of the at least one DER. The automation application may transmit the instruction to the structure based on the variation of operation of the at least one DER. The at least one server may be further configured to execute an energy efficiency model configured to measure efficiency of the at least one DER at the structure. The automation application may transmit the instruction to the structure based on the efficiency of the at least one DER. The DER may be an HVAC system, a battery, or an electric vehicle charger. The automation application may be configured to select a plurality of structures for the energy adjustment based on the occupancy of the plurality of structures. The automation application may be configured to select a plurality of structures for the energy adjustment based on the need based on the occupancy of the plurality of structures, a comfort level of the plurality of structures, and an energy efficiency of the plurality of structures.

In another embodiment, a method may comprise detecting, by at least one processor, an increase in energy pricing or a decrease in energy capacity; generating, by the at least one processor, a demand response event instruction; identifying, by the at least one processor, which subset of a plurality of structures qualifies for the demand response event instruction, wherein the identifying comprises determining an occupancy state for each structure; and transmitting, by the at least one processor, the demand response event instruction to the subset of structures that qualify.

Determining the occupancy state for each structure may comprise executing, by the at least one processor, an occupancy machine learning model configured to receive sensor data from the structure and output a state of occupancy for the structure. Identifying may further comprise determining an energy efficiency of each structure. Determining the energy efficiency for each structure may comprise executing, by the at least one processor, an occupancy machine learning model configured to receive distributed energy resource (DER) data from the structure and measure efficiency of the at least one DER at the structure. Identifying may further comprise determining a comfort level of each structure. Determining the comfort level for each structure may comprise executing, by the at least one processor, an occupancy machine learning model configured to measure a variation of operation of the at least one distributed energy resource (DER) from a user's setting of the at least one DER. The demand response event instruction may adjust energy consumption by a distributed energy resource (DER) of the structure. The DER may comprise an HVAC system, a battery, or an electric vehicle charger.

In yet another embodiment, a method may comprise detecting, by at least one processor, an increase in energy pricing or a decrease in energy capacity; generating, by the at least one processor, a request for an energy consumption adjustment based on the energy pricing or energy capacity; identifying, by the at least one processor, which subset of structures of a plurality of structures qualifies for the energy consumption adjustment, wherein the identifying comprises determining an occupancy state for each structure; generating and transmitting, by the at least one processor, a notification to the subset of a plurality of structures requesting participation in the energy consumption adjustment; upon receiving a response from a structure of the of the plurality of structures to participate, transmitting, by the at least one processor, an instruction to the subset of structures for the energy consumption adjustment; and upon detecting an implementation of the energy consumption adjustment by each structure, automatically allocating, by the at least one processor, a reward to an account for each of the subset of structures.

Determining the occupancy state for each structure may comprise executing, by the at least one processor, an occupancy machine learning model configured to receive sensor data from the structure and output a state of occupancy for the structure. Identifying may further comprise determining an energy efficiency of each structure. Determining the energy efficiency for each structure may comprise executing, by the at least one processor, an occupancy machine learning model configured to receive distributed energy resource (DER) data from the structure and measure efficiency of the at least one DER at the structure. Identifying may further comprise determining a comfort level of each structure. Determining the comfort level for each structure may comprise executing, by the at least one processor, an occupancy machine learning model configured to measure a variation of operation of the at least one distributed energy resource (DER) from a user's setting of the at least one DER. The energy consumption adjustment may adjust energy consumption by a distributed energy resource (DER) of the structure. The DER may comprise an HVAC system, a battery, or an electric vehicle charger, or the like.

### BRIEF DESCRIPTION OF THE DRAWINGS

The accompanying drawings constitute a part of this specification, illustrate an embodiment, and, together with the specification, explain the subject matter of the disclosure.

FIG. 1 illustrates an example system architecture of a system, according to an embodiment.

FIG. 2 illustrates a flow diagram of an example method for dispatching the system, according to an embodiment.

FIG. 3 illustrates an example system architecture of a structure, according to an embodiment.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

A Distributed Energy Resource Management System (DERMS) can optimize energy distribution by leveraging Distributed Energy Resources (DERs) like thermostats, EV chargers, and home battery storage to provide power to different components of a building. The DERMS can manage DERs by shifting energy among devices and home. During peak demand, the VPP can minimize the cost to procure power for the structure, reduce demand on the grid, and ultimately reduce long-term consumer costs. Energy data, cost data, and home occupancy information from the occupancy machine learning model can be used to manage energy distribution in a virtual power plant (VPP) and tailor energy usage based on real-time occupancy data as well as consider comfort levels and energy efficiency.

In one embodiment, the DERMS may use occupancy data to dispatch a VPP. The system can track occupancy patterns. If a user is not at a structure (e.g., the structure is not occupied or has an unoccupied state), the DERMS can instruct that the structure adjust the temperature according to an unoccupied schedule. If the structure is occupied, the DERMS may use an occupied schedule different from the unoccupied schedule. In one configuration, a thermostat can be customized based on occupancy. For example, if the DERMS knows that the user will be home at a given time, range of times, etc., the HVAC can precondition (e.g., pre-cool) the house to a cooler temperature before the hottest part of the day.

In another embodiment, the DERMS can use occupancy data in combination with other smart home sensor data to determine which structures qualify for a dispatched VPP. The location of a user may be identified using sensors from the structure and/or an app from a user device. The system can cluster users into groups. The users can input a state of the structure into the DERMS, or the DERMS can automatically determine the state. The system may orchestrate dispatches based on the various states. States can include, but are not limited to, on vacation, long away, short away, away during school hours, away during work hours, home and active, and home and asleep. In one example configuration, a home in a “vacation” state can be adjusted more and for a longer duration than a home that is more often in an occupied state (e.g., away during work hours, home and active, home and asleep). The system can also analyze and predict consumption patterns, whereby the user can have an energy rate plan matching consumption to the energy rate plan. The system may dispatch to those users that are classified for high peak energy dispatches, those users that are classified for low peak energy dispatches, and those users that have customized dispatches, which can be based on specific strategies or schedules. The system may utilize energy efficiency of a structure and orchestrate a dispatch based on the efficiency or lack of efficiency in a structure. The users can be clustered based on the structures' efficiency (including efficiency of an appliance, HVAC, or other system within that structure). The DERMS is in communication with each DER and aware of availability and capacity of each DER. For example, the DERMS is aware of a capacity and charge percentage of a home or vehicle battery, or whether a home temperature is at, above, or below a desired temperature and the HVAC's ability to move to the demand response temperature and/or back to the desired temperature.

In another embodiment, the DERMS can incentivize participation in a dispatch using gamification. The user is provided a notification about a potential reward if the structure participates in the dispatch. For example, if the thermostat increases by one degree between 3-6 pm, then the user will receive a credit or reward. Using sensor data, the DERMS can track to detect the increase of one degree and automatically issue the credit or reward. In another example, a user may be incentivized by stating that a back door or a window is usually open for 30 minutes between 2-5 pm, but if the user keeps it open for less than 5 minutes, the user will receive the credit or award. The system can use a sensor on the door or window to detect whether the door or window is open or closed. The notification to close the back door or window can be triggered for action by the user during peak times of energy use. Users can also receive options such as stop charging an electric vehicle. The system can allow users to set energy savings goals and give suggestions and send notifications of actions that can satisfy those energy savings goals.

In another embodiment, the DERMS has more options for specially configured dispatch based on additional information about structures. For example, the additional information could be an occupancy state. In this example, the DERMS could dispatch instructions (e.g., instructions to reduce energy usage) to structures having occupants in a “vacation” state and then escalate, as needed, to include those structures where the occupants are in a “long away” state. The system can orchestrate a dispatch to balance the DERMS control and a user's desire for sense of control. The dispatch actions can be automated and based on energy pricing as well as occupancy and state conditions. The DERMS can consider a real-time assessment of available DERs and their respective capacities by region. The system can assess and orchestrate the use of the lowest cost energy sources selected amongst different power plants, renewables, and available VPP options (e.g., available home battery capacity and temperature adjustment capacity). This orchestration can be performed on a macro level and by region. The DERMS can have visibility into how much VPP capacity is available. A VPP usage of a structure can be tracked, and the DERMS may attempt to avoid a dispatch to a structure too often while occupied so that the customer is not disrupted or uncomfortable. The system can also predict a number of users who may opt-out or opt-in of a demand response or a notification for an adjustment based on historical data over one or more users, structures, regions, climates, weather patterns, etc.

### Example Architecture

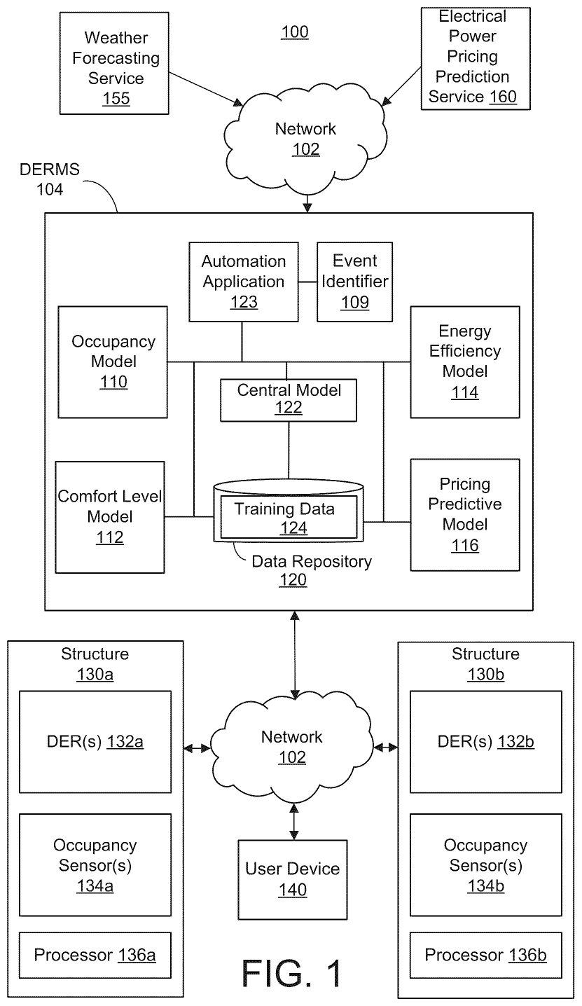

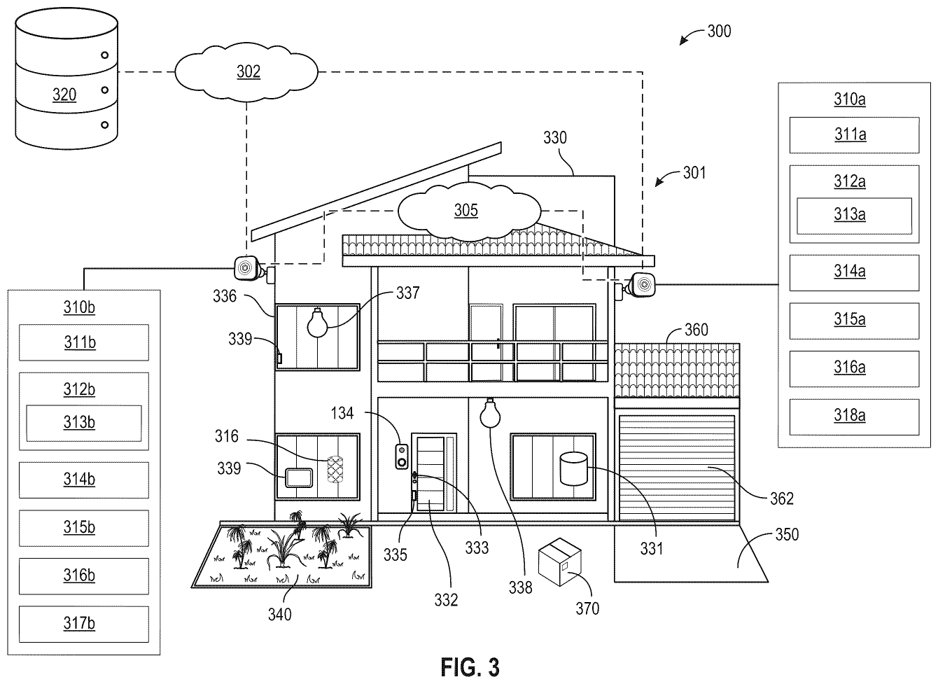

FIG. 1 illustrates an example architecture of a system 100 that may be used to manage the energy consumption of one or more structures, such as a structure 330, described in further detail in FIG. 3. The system 100 can include a DERMS 104, structures 130a, 130b (together structures 130, individually structure 130) (such as a home or other building), and/or user device(s) 140. The structures 130 can include any number of structures. The DERMS 104 can receive and analyze data from structures 130, and/or the user device 140. The system 100 can allow the DERMS 104, structures 130, and the user device 140 to communicate (e.g., transmit data, send/receive messages, etc.) via the network 102, such as a WAN using the Internet.

### Structures

The structures 130 can be or include homes or other buildings. The structure 130a can be or include one or more DERs 132a and/or one or more occupancy sensors 134a. DERs 132a can be or include devices that generate, store, and/or use energy (e.g., renewable energy) within a structure. Examples of DERs 132a may be or include thermostats, electric vehicle chargers, home battery storage devices, and/or air devices (HVAC), etc.

The occupancy sensors 134a can be or include different sensors that can detect or measure occupancy within specific areas of a structure and/or within the entirety of the structure. For example, the occupancy sensors 134a can be or include motion detectors, cameras, door/window contacts, and other sensors. The occupancy sensors 134a can generate and/or store data indicating the occupancy of the structure 130a over time. The structure 130b can include similar DERs 132b and/or occupancy sensors 134b. The DERs 132a, 132b can be referred to herein separately as DERs 132 and together as DERs 132. The occupancy sensors 134a, 134b can be referred to herein separately as occupancy sensors 134, and together as occupancy sensors 134.

The structures 130 can respectively include processors 136a, 136b (separately, processor 136, and together, processors 136). The processors 136 can be or include any type of processor coupled to a memory that is configured to receive data from the DERs 132 and/or occupancy sensors 134 and communicate the received data with the DERMS 104. The processors 136 can additionally or instead be configured to receive messages or instructions from the DERMS 104 to control the DERs 132 and/or the occupancy sensors 134. For example, the processor 136a can receive dispatch instructions from the DERMS 104 to control a thermostat of the DERs 132a to reduce the temperature within the structure 130a. In another example, the processor 136b can receive dispatch instructions from the DERMS 104 to control a thermostat of the DERs 132b (i.e.,., HVAC equipment) to increase the temperature within the structure 130b. In some cases, the DERMS 104 can dispatch instructions directly to a thermostat to control HVAC equipment within a structure 130 or to any other DER 132 within the structure 130.

Each structure 130 can receive tailored instructions during demand response (DR) events or other instructions to control the energy usage. Although example embodiments may describe instructions using a DR event, it is intended that the systems and methods may be configured for other instructions to DERs that are not part of a DR event. DR events can be periods in which consumers are requested to reduce or shift their electricity usage in instructions that the DERMS 104 transmits to the respective structures. The DERMS 104 can calculate or determine the instructions based on various factors, such as the structure's occupancy status, the efficiency of installed systems, and historical energy usage patterns. Each structure 130 (e.g., home or building) can receive individualized, demand response event specific dispatch instructions (e.g., VPP dispatch instruction) for that structure 130 during a specific demand response event based on some or all of the factors. In one example, in homes where no one is present, the DERMS 104 can send instructions to make larger adjustments to reduce the energy consumption of energy-consuming devices such as HVAC systems, water heaters, and other appliances (e.g., smart appliances). The adjustments in energy reduction can be larger in structures that are not occupied because the instructions are unlikely to impact resident comfort. Thus, the DERMS 104 can cause the unoccupied structure to contribute more significantly to demand response efforts without affecting the quality of life or comfort of any structure occupants.

In some cases, one or more of the structures 130 can undergo preconditioning in anticipation of a demand response event in which the structures 130 are expected to reduce energy consumption. Preconditioning can involve adjusting the internal temperature of the structure 130 before a demand response event is scheduled to occur. For example, in anticipation of a peak energy demand period on a hot day, the DERMS 104 can instruct an efficient HVAC system to pre-cool the home just before the DR event, when energy demand is lower. Preconditioning structures 130 in this way can utilize energy at a more cost-effective time and can reduce the burden on the grid during peak hours. By preemptively cooling the home, the temperature can be maintained at a comfortable level for a longer duration with minimal additional energy input, even when the DERMS is dialed back during the demand response event. Preconditioning can be a strategic way to maintain comfort while still participating actively in energy reduction during demand response events.

### DERMS

The DERMS 104 may be or include one or more application servers and/or a virtualized environment in the cloud. In some cases, the DERMS 104 can be a software module or set of executable instructions that can be executed by one or more processors to perform the systems and methods described herein. The DERMS 104 can operate as a single server or operate as multiple servers or computers in a distributed processing system. The functionality of the DERMS 104 can be contained within one system or distributed amongst different processors, servers, and/or computers, which may be located remotely from each other. The DERMS 104 may be in a cloud environment, located at an energy or utility company, located at each structure, and or configured in a combination of one or more of these locations.

One or more of the operations performed by the DERMS 104 as described herein may be performed by a device or software module separate from any DERMS. For example, one or more of the operations can be performed by one or more cloud servers, one or more separate computing devices, and/or by one or more of the processors 136 of the structures 130 in addition to or instead of by the DERMS 104. In cases in which operations are performed separately from the DERMS 104, the computing devices that perform the operations can transmit instructions for a demand response event to the DERMS 104 that the DERMS 104 can repackage in a new message with the instructions or otherwise forward to the structures 130 for control of the DERs 132 for the demand response event. In some instances, the DERMS 104 can monitor the structures 130 to receive data to send to the devices that the devices can use to generate the instructions. Thus, the DERMS 104 can operate as middleware that facilitates the exchange of communication between the structures 130 and the computing devices for demand response events.

The DERMS 104 can be configured to process data (e.g., smart home data) from different structures 130 and generate dispatch instructions to control DERs of the structures 130. The DERMS 104 can generate the dispatch instructions based on the data (e.g., occupancy data and/or data from the DERs 132) that the DERMS 104 receives from the structures 130 (e.g., from the processors 136).

The DERMS 104 can determine “useable” performance data. For example, the DERMS 104 can measure the baseline electricity consumption of the structures 130 within the aggregation compared to their performance during a demand response event. Doing so can facilitate the DERMS 104 performing meaningful evaluation of and useable data from the performance of the aggregation. Useable performance data can mean that the data is useable with respect to potential external market opportunities (e.g., ERCOT ancillary services) and transmission and distribution utility load management programs.

Although not shown, the DERMS 104 may comprise a network interface, a processor, and/or memory. The DERMS 104 may communicate with the processors 136, the user device 140, the weather forecasting service 155, and/or the electrical power pricing prediction service 160 over the network 102. The DERMS 104 may do so via the network interface, which may be or include an antenna or other network device that enables communication across a network and/or with other devices. The processor may be or include an ASIC, one or more FPGAs, a DSP, circuits containing one or more processing components, circuitry for supporting a microprocessor, a group of processing components, or other suitable electronic processing components. In some embodiments, the processor may execute computer code or modules (e.g., executable code, object code, source code, script code, machine code, etc.) stored in memory to facilitate the activities described herein. The memory may be any volatile or non-volatile computer-readable storage medium capable of storing data or computer code.

The DERMS 104 may include (e.g., in memory) an event scheduler 109, an occupancy model 110, a comfort level model 112, an energy efficiency model 114, a pricing predictive model 116, a data repository 120, a central model 122, and/or an automation application 123. In brief overview, the components 109-123 may collect data (e.g., occupancy data) from the structures 130. The components 109-123 may determine to initiate a demand response event. The components 109-123 may determine to initiate the demand response event based on energy from the grid being unavailable or otherwise having limited availability. The components 109-123 may determine to initiate the demand response event based on the price of energy from the grid exceeding a threshold, for example. Responsive to detecting the demand response event, the components 109-123 can use data (e.g., smart home data) of the structures to generate dispatch instructions that include instructions to adjust the configuration of the DERs 132 or for the DERs 132 to adjust energy usage. For instance, the components 109-123 can execute the models 110-122 to generate predictions regarding the occupancy of the structures 130, occupancy schedules of the structures 130, the efficiency of the HVAC systems of the structures 130 to adjust before discomfort (e.g., by predicting available demand response time and energy savings per home), and/or occupant comfort preferences. The components 109-123 can generate instructions for the different structures 130 based on the predictions, in some cases by optimizing a balance between energy price, home occupancy, and home comfort level for each set of instructions. The components 109-123 can transmit the instructions to the processors 136 of the structures 130. The processors 136 may operate or otherwise adjust the configurations of the DERs 132 based on the transmitted instructions. Thus, the components 109-123 can cause the DERs 132 to change (e.g., reduce) the amount of energy that the DERs 132 consume during a demand response event.

The event scheduler 109 may comprise programmable instructions that, upon execution, cause the DERMS 104 to determine instances in which to initiate demand response events or time periods for the structures to reduce or shift energy or electricity usage. The event scheduler 109 can communicate with other components of the system 100 through the network interface of the DERMS 104. For instance, the event scheduler 109 can communicate with the weather forecasting service 155 (e.g., a service provider that provides real-time and/or predictive weather forecasts) via the network 102 to receive a weather forecast. For example, the event scheduler 109 may obtain forecasted outside air temperatures for the location of the structure 130 during a prediction time period, such as the next 24-hour period. In one example, a DERMS 104 may take in weather data to determine NOT to dispatch a particular DER due to consumer safety, for example; leave battery SOC if it will be needed for customer to have backup power through a storm or let an EV charge in anticipation of an evacuation.

Similarly, the event scheduler 109 may communicate with the electrical power pricing prediction service 160 (e.g., a service provider that provides real-time and/or predictive grid pricing forecasts) via the network 102 in order to receive electrical power pricing predictions, such as next day predicted pricing as a function of time. The event scheduler 109 may be configured to receive data from the electrical power pricing prediction service 160 via the network 102. One example of the electrical power pricing prediction service 160 may be the Electrical Reliability Council of Texas (ERCOT), which provides real-time spot market projected and actual price signals.

The event scheduler 109 can determine to initiate demand response events based on the pricing from the weather forecasting service 155 and/or the electrical power pricing prediction service 160. For example, the event scheduler 109 may determine that the current price of the energy from the grid exceeds a threshold or is projected to exceed the threshold in the future based on data from the electrical power pricing prediction service 160. Responsive to the determination, the event scheduler 109 can trigger for the central model 122 to generate instructions to control the DERs 132 of the structures 130 to reduce or shift the energy use of the DERS 132. In another example, the event scheduler 109 may determine the forecasted temperature in a region is above a threshold. This forecast may indicate that homes or structures may use an increased amount of energy with the HVAC system to cool down the structures which will put strain on the energy grid. Accordingly, responsive to the determination, the event scheduler 109 can trigger for the central model 122 to generate instructions to control the DERs 132 of the structures 130 to reduce or shift the energy use of the DERS 132 for the projected time period in which the temperature is forecast to be above the threshold.

In one example, the event scheduler 109 may detect or predict a price spike from an energy forecast, such as the ERCOT day-ahead energy price. Responsive to detecting or predicting the price spice, the DERMS 104 may generate and transmit a request to the structures 130 to reduce consumption until the price falls below a threshold amount. The amount of consumption to reduce may be based upon the price with respect to a particular threshold, whereby a first threshold (e.g., $500 per megawatt) requires a first amount of energy consumption reduction, and a second higher threshold (e.g., $5000 per megawatt) requires a second higher amount of energy consumption reduction, for example.

The central model 122 may comprise executable instructions that, when executed cause the DERMS 104 to execute the machine learning models 110-116 to predict energy pricing trends and/or generate data to use to generate instructions to send to the structures 130 to control the DERs 132 in a demand response event. The central model 122 may do so responsive to the event scheduler 109 determining to initiate a demand response event. The occupancy model 110 (e.g., an occupancy machine learning model) can be a machine learning model (e.g., a neural network, a support vector machine, a random forest, etc.) that is configured to collect and/or process data from various sources (HVAC systems, security systems, smart devices, etc.) to determine a current and/or a future occupancy state of each structure 130 (e.g., at home, away at work, away on vacation, at home asleep). The comfort level model 112 (e.g., a comfort level machine learning model) can be a machine learning model that is configured to generate a comfort score or classify each structure 130 with different comfort levels (e.g., high tolerance, intermediate tolerance, and low tolerance). The energy efficiency model 114 (e.g., an energy efficiency machine learning model) can be a machine learning model that is configured to evaluate the energy efficiency of each structure 130 by analyzing data on DERs 132 such as HVAC, EV chargers, and battery storage system performance and energy consumption patterns. The pricing predictive model 116 can be a machine learning model that is configured to monitor real-time market data for energy prices and predict future energy pricing trends. The pricing predictive model 116 can allow the DERMS 104 to anticipate energy distribution strategies and identify patterns and anomalies in energy pricing for strategic planning. The models 110-116 can generate the predictions based on data that is collected from the respective structures 130 and/or stored in the data repository 120.

The data repository 120 may be, or include, a relational or graphical database. The data repository 120 may store training data 124 for one or more models utilized by the automation application 135. The data repository 120 may store data that the automation application 135 collects from the structures 130, for example. In some cases, the data may be collected periodically throughout a prediction time period, such as every 10 or 15 minutes. Some of the data may be obtained from DERs, such as a smart thermostat or other connected devices at the structure 130. Other data may be obtained from third-party services, such as a weather forecasting service 155 and/or an electrical power pricing prediction service 160. For example, predicted and actual outside air temperature or other weather conditions may be obtained from the weather forecasting service 155. The data from the smart thermostat may include a current or recent inside air temperature measurement, the HVAC operating mode (heating/cooling) and status (active/inactive), and maximum and minimum inside air temperature setpoints. A timestamp at which the data was collected may be obtained from the smart thermostat or associated with the data when the automation application has collected the data. The central model 122 can retrieve data from the data repository 120 that correspond to the time period of the demand response event and/or a predetermined time frame prior to the demand response event and use the retrieved data as input to execute the models 112-116 to generate respective outputs.

The central model 122 can determine operations or actions for the DERMS 104 to perform. The central model 122 can analyze and process a range of variables (e.g., input and/or output from other models in the DERMS 104) to determine actions for the DERMS 104 to optimize the balance between energy price, home occupancy, and home comfort level. The actions for the DERMS 104 can depend on the energy supply and demand and/or available energy capacity. The central model 122 can determine which structures 130 to dispatch for demand response events based on analysis of data relating to energy efficiency, occupancy, comfort level, and/or available energy capacity that may be generated by the machine learning models 110-116.

For example, the central model 122 can orchestrate the timing and magnitude of demand response events, selectively engaging structures that have indicated availability through the occupancy model 110 and are likely to incur the least discomfort impact as assessed by the comfort level model 112. The central model 122 can evaluate energy efficiency model 114 predictions. In doing so, the central model 122 can select structures 130 that can provide the most significant load reduction. The central model 122 can direct the DERMS 104 to dynamically manage energy distribution, reducing or shifting load in response to real-time market prices and grid demands, thereby enhancing the DERMS' 104 ability to offer competitive energy services and contribute to grid stability. The central model 122 can predict the power savings available for a demand response event at a particular day/time period based on some or all of the factors and a desired optimization of the priorities.

The central model 122 can use outputs from one or more of the occupancy model 110, the comfort level model 112, the energy efficiency model 114, and/or the pricing predictive model 116 to select the structures 130 for which to generate dispatch instructions for a demand response event (e.g., participate in the demand response event). In one example, the central model 122 may identify or select a subset of the structures 130 that are not currently occupied or that otherwise are not predicted to be occupied by the occupancy model 110 for the demand response event for which to generate and/or transmit dispatch instructions. In another example, the central model 122 may identify or select a subset of the structures 130 for which the comfort level model 112 indicates a change in operation of DERs of the respective structures will have the smallest impact on comfortability of the occupants. In another example, the central model 122 may identify or select a subset of the structures for which the energy efficiency model 114 determines a change in operation will be the most energy efficient. In another example, the central model 122 can select the subset of the structures using a function or based on the outputs of one or more of the occupancy model 110, the comfort level model 112, the energy efficiency model 114, and/or the pricing predictive model 116. For instance, the central model 122 can apply weights (e.g., predefined weights) to the outputs and aggregate the values of the outputs to identify the weighted sum or weighted output for each structure 130. The central model 122 can identify a defined number (e.g., one or more than one) of the structures with the highest weighted sum or weighted output to participate in the demand response event and generate and/or transmit instructions. The central model 122 can perform the selection process separately for each demand response event to ensure the selection process is accurate and using up-to-date information or perform the selection process at defined intervals or upon a receipt of a request from a computing device to reduce the computer resources and/or latency that may be required or involved in selecting structures to participate. The central model 122 can select the structures 130 to participate in any manner.

In some cases, the central model 122 may select structures to participate in the demand response event by requesting for the structures to “opt in” to participating. For example, the central model 122 may transmit a notification or message to computing devices (e.g., the user device 140) of or associated with different structures 130. The central model 122 can transmit the notification or message as an email, text message, push notification, phone call, etc. The central model 122 may transmit the notification responsive to the event scheduler 109 determining to initiate a demand response event. The notification can be a request to opt in to participate in a demand response event (e.g., help reduce strain on the grid) and/or to opt in to participate in future demand response events without requiring a second opt in. The notification can include an opt in button and/or an opt out button. Users can view the notifications and select one of either the opt in button or the opt out button and cause the computing device to transmit a message to the DERMS 104. The central model 122 can receive the selection and store a flag or an indication of the selection in accounts of the respective users or structures associated with the selections. The central model 122 may only generate and/or transmit instructions to structures 130 that have an opt in to participate indication or flag stored in their respective accounts for the demand response event.

In some cases, the processors 136 of the structures may determine (e.g., automatically determine) when or whether to opt in for a demand response event. For example, a processor 136 can use data collected from sensors of a home to determine if the home is ready for a demand response event by (i) determining if the home is occupied/occupancy schedule; (ii) measuring the temperature of the home and assessing how long the home will be able to say within a comfort zone/temperature zone (may be based on weather data), (iii) measuring customer comfort threshold/data/indications; (iv) receiving weather data and determining predicted energy usage for the demand response event based on the weather data. The processor 136 can do so responsive to receiving an indication from the DERMS 104 indicating the demand response event. The processor 136 can input the outputs (i)-(iv) into a function or a machine learning model configured to determine whether to participate in the demand response event and execute the function or machine learning model. The processors 136 can transmit the result to the DERMS 104, and the DERMS 104 can generate or not generate instructions for the home for the demand response event accordingly.

The central model 122 can generate individualized dispatch instructions. The central model 122 can generate individualized dispatch instructions for the subset of the structures 130 that the central model 122 selected to participate in the demand response event. The central model 122 can generate the dispatch instructions based on outputs from one or more of the occupancy model 110, the comfort level model 112, the energy efficiency model 114, and/or the pricing predictive model 116. For example, the central model 122 can generate dispatch instructions to lower the energy usage of DERs 132 in structures 130 that are unoccupied more than structures 130 that are occupied. In another example, the central model 122 can scale the change in energy based on comfort scores that are output for the structures 130 by the comfort level model 112 that indicate a level of comfort of occupants of the structures 130 with changes in the configuration of the DERs 132. The central model 122 may adjust the energy usage in structures 130 with higher comfort scores (or lower comfort scores, depending on the configuration) more than structures 130 with lower comfort scores. In some cases, the central model 122 may only take the output from the comfort level model 112 into account when generating instructions for structures 130 that are occupied. In another example, the central model 122 may generate instructions to change the energy usage of DERs 132 of individual structures 130 for which such a change will have the highest efficiency. The central model 122 can identify the DERs 132 based on an output of the energy efficiency model 114. The central model 122 can generate instructions to change the configuration of DERs 132 based on any combination of the occupancy model 110, the comfort level model 112, the energy efficiency model 114, and/or the pricing predictive model 116.

In some cases, the event scheduler 109 can determine to initiate a demand response event in response to receiving a request with an energy reduction target. The event scheduler 109 can receive the request from a computing device across a network. Responsive to receiving the request, the central model 122 can execute the models 110-116 to generate instructions that, if followed, will cause structures 130 to reduce the energy usage of energy from the grid by at least the energy reduction target.

In some cases, the event scheduler 109 can determine to initiate a demand response event to prepare for a high cost period (e.g., when to initiate a preemptive demand response event). The central model 122 may identify a time before the high cost period to initiate a demand response event. For example, the central model 122 can determine the beginning of a pre-high cost period where the HVAC should begin precooling or preheating using the same process used in predictions except the calculations are performed in reverse chronological order from the timepoint when the higher prices are predicted to begin. If it is hot outside, the application may cause pre-cooling of the consumer's home down as low as the minimum temperature setpoint. For precooling, a cooling regain coefficient associated with an appropriate key value (for the current inside/outside temperature differential) may be used and multiplied by the duration between timepoints. The resulting temperature change is then subtracted from the current predicted inside air temperature. This process is repeated until the predicted inside air temperature is equal to or less than the consumer's minimum temperature setpoint, and the corresponding timepoint is used as the beginning of the precooling time period.

The automation application 135 may comprise programmable instructions that, upon execution, cause the DERMS 104 to utilize processed data of the DERMS 104 to communicate with other components of the system 100, and, in some instances, generate instructions for the processors 136 to control electricity consuming devices (e.g., DERs 132) at the structure 130. The automation application 135 may be communicatively coupled via the network 102 to the other components of the system 100, such as the user device 140.

The automation application 135 may transmit instructions to control the DERs 132. For example, the central model 122 can select a subset of structures 130 for which to generate and/or transmit instructions for a demand response event. The central model 122 can generate instructions for the demand response event for the selected structures based on outputs from the models 110-116. The automation application 123 can generate individual messages for the selected structures 130 that include instructions that the central model 122 generated for the demand response event. The automation application 123 can transmit the instructions to processors 136 of the respective structures 130. The processors 136 can receive the instructions and control or adjust the configurations the DERs 132 of the respective structures 130 according to the instructions. In other embodiments, the automation application 135 may provide an instruction to a third-party device monitoring service using an application programming interface (API) that forwards the instruction to the processors 136.

The DERMS 104 can (e.g., via the automation application 123) optimize energy distribution in the structures 130 through the DERs 132 (such as thermostats, EV chargers, and home battery storage) of the structures 130 by transmitting instructions to shift energy among devices and structure 130. Although the present disclosure describes using DERMS 104 to manage the DERs 132 of the structures 130, the system 100 can also be configured to use other control systems to manage DERs 132 or other energy consuming resources of structures 130. DERs 132 can be individually controlled to either generate, store, or conserve energy based on the needs of the grid and the pricing signals. The DERMS 104 can manage the operations of DERs 132, effectively shifting energy load between devices within structures 130 and across the network of connected homes 130. For example, the DERMS 104 can temporarily reduce the charging rate of EV chargers or adjust the power consumption of smart home appliances during peak demand times to alleviate stress on the grid. The DERMS 104 can dispatch energy stored in home battery systems back into the grid during high-price energy periods, thus turning residential units into active grid-supportive participants. The DERMS 104 can facilitate the shift from traditional, centralized energy production to a more distributed model where energy can be generated, stored, and managed at or near the point of consumption. The DERMS 104 can control energy resources thereby increasing operational efficiency, and enabling new business models for energy services.

In some cases, the DERMS 104 can select a subset of enrolled subscribers to participate in a demand response event based on some or all of the factors. The selection can be based on a comprehensive analysis of various factors, including the individual energy consumption profiles, the availability of the DERs 132, the predicted occupancy states of the subscribers' structure 130, and their historical responsiveness to demand response events. By leveraging data from smart meters, IoT devices, and user inputs, the DERMS 104 can predict which subscribers are most likely to contribute effectively to a demand response event without significantly disrupting their comfort or operational routines.

The DERMS 104 can manage the demand response events. For example, subscribers with solar panels and home battery storage systems may be selected to contribute surplus stored energy during peak demand hours, while those with smart thermostats may have their temperature settings adjusted (e.g., by a degree or two) to reduce the load on the grid. The DERMS 104 can ensure that the effects of adjusting power consumption can be distributed across the network of structures 130 in the system 100.

In some cases, a decision-making tool for orchestrating a demand response event dispatched by the DERMS 104 can select structures to generate and/or transmit dispatch instructions based on occupancy information made using real-time sensor data (e.g., only select structures that are occupied or only select structures that are not occupied, depending on the configuration). The data can include motion detectors, smart meters, and connected thermostats, allowing the occupancy model 110 to determine the presence or absence of occupants. By using the occupancy data, the DERMS 104 can ensure that energy adjustments during a demand response event are targeted and effective, minimizing disruptions to occupants and maximizing the potential for energy savings across the network.

The DERMS 104 can select the structures based on any type of data. For example, the DERMS 104 can select structures to generate and/or transmit dispatch instructions based on (i) people who opt-in to higher tiers of DR participation, (ii) people away from home briefly, on vacation, or away for extended periods; (iii) people known to be away from the home based on alarm setting; (iv) people are known to be away from home based on analyzed schedule; and/or (v) people's location within an applicable geographic region.

The DERMS 104 can present available capacity from a potential or implemented demand response event to a computing device (e.g., a trading desk computing device). For example, the DERMS 104 can utilize a comprehensive set of data analyses, predictive modeling, and real-time monitoring to determine the amount of power that can be made available during a demand response event. This can include calculating the expected reduction in demand by controlling HVAC systems, managing EV charging times, and leveraging home battery storage capabilities. The DERMS 104 can predict the quantity of power available and the duration for which this power can be sustained, providing the computing device with information for making informed decisions in the energy market.

The system 100 can be scalable. For example, the DERMS 104 can generate a VPP dispatch schedule with levels of severity for a single potential demand response event and adjust the VPP dispatch schedule as needed. The DERMS 104 can orchestrate the severity of a dispatch based on the cost of power based on some or all of the factors. A scalable VPP dispatch schedule can be adaptive, with the capability to implement various levels of severity for a single potential demand response event. The DERMS 104 can deploy different levels of demand response measures depending on the urgency and magnitude of the demand on the grid. For example, in a situation where there is a forecasted spike in energy demand, the DERMS 104 may initiate a low-severity level, which can involve minor adjustments to HVAC settings across participating homes. If the demand were to increase unexpectedly, the DERMS 104 can escalate to higher severity levels, implementing more significant energy-saving measures such as larger temperature adjustments, deferring the operation of major appliances, temporarily reducing the charge rate of electric vehicles, or including more DERs. In some cases, the DERMS 104 can allow users to opt-in to different severity levels for their homes, such as by providing an input indicating a severity level into a computing device and causing the computing device to transmit the input or indication to the DERMS 104.

The VPP dispatch schedule may not be static. For example, the VPP dispatch schedule can be subject to continuous optimization during a demand response event. If real-time analytics indicate that the grid is stabilizing, the DERMS 104 can reduce the severity of the measures in place, thus minimizing inconvenience to consumers. When conditions worsen, the DERMS 104 can intensify its demand reduction strategies.

The DERMS 104 can customize a VPP dispatch schedule based on an input of needed energy savings. For example, a trading desk computing device in communication with the DERMS 104 can request an energy quantity and region, and the DERMS 104 can calculate the orchestration required to meet the energy that request. The DERMS 104 can analyze the energy consumption patterns, availability of DERs, and potential flexibility within the network of enrolled subscribers. The DERMS 104 can determine the most efficient and least disruptive way to orchestrate the aggregate energy resources to meet the specified energy savings request. The DERMS 104 can communicate available capacity based on various factors such as current grid load, the mix of renewable versus traditional energy sources being utilized, and the specific energy needs of the system 100′s network of connected homes and businesses. The DERMS 104 can enable trading desk computing devices to optimize their bids and offers in the energy market, enhancing the economic efficiency of their operations. The system analytics can allow for the anticipation of grid events that might necessitate additional capacity or periods when excess energy could be sold on the market. Through a continuous feedback loop of data, the DERMS 104 can ensure that trading desk computing devices have access to the most up-to-date information, allowing for proactive market participation.

### User Device

The user device 140 may be a mobile phone, panel device, hub device, laptop computer, desktop computer, smart watch, or other computing device. The user device 140 may provide a user interface enabling a user to setup and configure the DERs 132 of the structure to be available for VPP functionality, respond to and participate in demand response events, and participate in other instructions to adjust energy consumption. The user device 140 may include a processor, memory or data storage device, a battery (or other power source), a universal serial bus (USB) port, a camera, and an audio codec coupled to a built-in speaker, a microphone, and an earphone jack. A touchscreen controller may provide a graphical output to a display device and an input from a touch input device. Collectively, the display device and touch input device may be referred to as a touchscreen. The user device 140 may also include a short-range wireless transceiver, a wireless local area network transceiver (“Wi-Fi transceiver”), a mobile communication transceiver for communication with a cellular communication network, and a global positioning system (GPS) transceiver. In an example configuration, the Wi-Fi transceiver enables the formation of a wireless local area network connection with the network 102. The memory may store one or more applications including program instructions that are executable by the processor. Such applications may include an operating system and applications that may generate an audible alert. Depending upon the task performed by the user device 140, the memory may include a device control program including program instructions that may be executed by the processor to cause the performance of various operations. The memory may also store applications, such as an app that enables the user to interface with and control energy consumption of the DERs 132.

The user device 140 can allow users (e.g., home occupants) to view changes made by the system 100 in their home energy consumption or operation. The user device 140 can allow users to begin, pause, delay, or cease participation of the structure 130 in the system 100. The user device 140 can allow users to override actions taken by the system 100 in their respective structures 130. The user device 140 can allow users to override classification of structure comfort level by allowing users to adjust their comfort level.

### Example Process

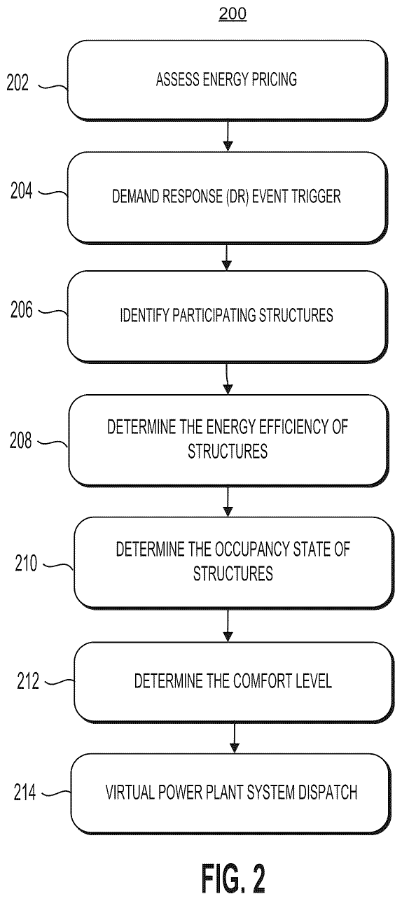

FIG. 2 illustrates a flow diagram of an example method 200 for dispatching customized instructions to structures in a demand response event. Additional, fewer, or different operations may be performed in the method 200 depending on the embodiment. At least one aspect of the operations is directed to a system, method, apparatus, or a computer-readable medium.

### Assess Energy Pricing

In operation 202, and in some implementations, the DERMS 104 can receive energy price data and/or energy price assessments. The energy price data and/or energy price assessments can be generated by the pricing predictive model 116, market reports, external sources, etc. The DERMS 104 can monitor grid conditions, dispatch and monitor resources, and provide event forecasting and analytics reporting. In some instances, the DERMS 104 may take or direct timely and appropriate real-time actions, such as a demand response event. The DERMS 104 can utilize energy price data and/or capacity to determine whether to initiate a demand response event.

The DERMS 104 can monitor (e.g., continuously monitor) real-time market data to assess current energy prices. Such energy prices can fluctuate based on supply and demand dynamics, weather conditions, and/or other market factors. This information can allow the DERMS 104 to make decisions (e.g., immediate decisions) on energy distribution, such as when to sell surplus energy back to the grid or when to store energy in home battery systems for later use.

The DERMS 104 can execute the pricing predictive model 116 to assess or predict energy pricing (e.g., predict current energy pricing or energy pricing a defined time period into future from input data). In doing so, the pricing predictive model 116 can analyze historical pricing data, the current and projected supply and demand balance, and/or other variables, such as weather patterns and consumption trends, to forecast future price movements. The pricing predictive model can allow the DERMS 104 to anticipate energy distribution strategies, optimizing for periods of low pricing to reduce costs and maximize efficiency.

The pricing predictive model 116 can identify cyclical patterns and anomalies in energy pricing, aiding in the strategic planning of energy production, storage, and consumption. By utilizing the pricing trends and the pricing predictive model 116, the DERMS 104 can anticipate periods of high or low pricing, aligning energy management strategies accordingly to benefit both the grid and the consumers. The system can integrate real-time data, predictive analytics, and historical insights to optimize energy distribution, thus improving or ensuring grid stability and cost efficiency. The DERMS 104 can assess or evaluate energy pricing over time to determine times or instances in which energy from the gird is predicted to exceed a threshold.

### Demand Response Event Trigger

In operation 204, the DERMS 104 can initiate a demand response event. The DERMS 104 can determine the need for a demand response event based on energy pricing, energy supply, and/or energy demand. For example, the DERMS 104 can execute the pricing predictive model 116 or analyze a pricing schedule to evaluate or determine the real-time cost of energy. The DERMS 104 can determine whether to initiate a demand response event based on the real-time cost of energy. For example, the DERMS 104 can utilize the pricing predictive model 116 to continuously monitor the energy market for real-time pricing signals. When energy prices exceed a threshold (e.g., a defined threshold), which may be indicative of high demand that the grid may struggle to meet, the DERMS 104 can initiate a demand response event. In doing so, the DERMS 104 can identify time periods in which there is peak demand on the grid and identify an opportunity to reduce energy consumption across a network of structures (e.g., homes and businesses) that are connected with the DERMS 104 and communicate with the structures to reduce demand at the structures to alleviate grid stress and capitalize on cost savings.

Responsive to determining to initiate the demand response event, the DERMS 104 can assess the availability and readiness of structures (e.g., participating homes and/or businesses) to respond to a demand response event. The assessment can includes checking the current status of energy consumption, the predicted occupancy, and the comfort level of the participants. By ensuring that a demand response event will not significantly impact the comfort or operations of participants, the DERMS 104 can align economic incentives with customer satisfaction. The DERMS 104 can consider the forecasted duration and intensity of the high-price period to determine the scale and length of the demand response event. If prices are expected to remain high for an extended period, the DERMS 104 may opt for a longer demand response event but with more moderate adjustments to energy consumption to prevent discomfort or disruption. Conversely, shorter periods of high prices may trigger a more intense demand response to quickly reduce demand and capture cost savings. The DERMS 104 can determine a demand response strategy to adjust the energy consumption of the different structure to reduce the demand on the grid.

The DERMS 104 can communicate with connected devices such as smart thermostats, EV chargers, and home battery storage systems of the structures to implement the demand response strategy. For example, the DERMS 104 can adjust smart thermostats to slightly increase or decrease temperatures to reduce HVAC load and/or defer EV charging. In some cases, the DERMS 104 can cause home batteries to supply energy to the different loads within the structures, thus reducing the demand from the grid. These actions can contribute to stabilizing the grid and can result in economic benefits for both the utility providers and consumers.

In one example, when the grid is experiencing peak demand, (e.g., on hot summer afternoons when air conditioners are running at full capacity) the DERMS 104 can initiate a demand response event to reduce the demand on the grid. In load shifting events, the DERMS 104 can move or shift energy consumption from peak demand periods to times when the grid is underutilized (e.g., at night). For instance, a system may delay the charging of electric vehicles or the operation of electric water heaters until off-peak hours. Demand response can be used for providing ancillary services like frequency regulation or spinning reserve. For example, if the frequency of the grid starts to drop, a demand response event can be triggered to quickly reduce load and help stabilize the grid.

A demand response event can be an instruction to adjust the energy consumption of one or more DERs of a structure. A demand response event may also be referred to herein as a dispatch. The DERMS 104 can assess the need for a demand response event based on energy pricing and supply-demand balance. The DERMS 104 can identify the potential need for a demand response event. The DERMS 104 can assess the availability and readiness of structures to respond to the demand response event.

### Identify Participating Structures

In operation 206, in some cases, the DERMS 104 can identify structures that are participating in the demand response event. For example, the DERMS 104 may only send instructions to adjust energy consumption of DERs 132 in a demand response event to a subset of structures that the DERMS 104 with which the DERMS 104 is configured to control. For instance, the DERMS 104 may only generate and/or send such instructions to those structures that have opted-in to monitoring and control. In other instances, the DERMS 104 may generate and/or transmit a notification to the user device indicating a desire to reduce consumption, such as lower air conditioning, reduce heat, or stop charging electric vehicle. The DERMS 104 may transmit the notification responsive to determining to initiate a demand response event, in some cases. The notification may be transmitted as a text message, email message, pop-up message, or other message on a smart device (e.g., mobile phone) or a panel or hub of a security or home automation system. Each user will have a certain amount of time to respond to the notification to accept the adjustment. For example, the user can respond to the message or select an option presented on a user interface. After the time for response has expired, the DERMS 104 will only instruct DERs for adjustment based on the responses received (e.g., based on received responses indicating to participate). In return, the user will receive a reward for participation.

The opt-in/opt-out mechanism can allow users control over their participation in demand response events. Users can opt-in to participate in the system to program and can also choose to opt-out of specific demand response events if they anticipate the need for greater comfort during those times. For example, if a user is hosting a gathering or if someone at home is ill, they may choose to opt-out of a demand response event to maintain a comfortable environment. This mechanism ensures that the system allows occupants autonomy and comfort while still promoting collective action to manage energy demand.

The effectiveness of demand response events relies heavily on the intelligent selection and grouping of homes, the smart adjustment of HVAC settings, and the participation of homeowners. The system can dispatch demand response events (e.g., instructions of the demand response events) that stabilize the grid and reduce costs, all while maintaining a focus on the comfort and satisfaction of consumers.

### Energy Efficiency of Structures

In operation 208, the DERMS 104 can determine an energy efficiency of the structure. For example, the DERMS 104 can execute the energy efficiency model 114 to assess the potential energy savings and the effectiveness of energy consumption. In doing so, the DERMS 104 may only assess the potential energy savings for structures that have “opted in” to participating in demand response events and/or this particular demand response event, thus reducing the processing resources that may be required when generating demand response event instructions for a large number of structures.

In some cases, the DERMS 104 can generate dispatch instructions based on categories of the homes or structures. For instance, the DERMS 104 can categorize homes or structures based on their energy efficiency (e.g., their HVAC system efficiency). Energy-efficient homes with advanced HVAC systems that can cool or heat quickly may be selected for more aggressive demand response strategies. In contrast, homes with less efficient systems might receive moderate adjustments to avoid compromising the comfort of the residents excessively. For example, in determining an HVAC system's usefulness for dispatch instructions, the DERMS 104 can compare the following to similar data from other HVAC systems: (i) HVAC duty cycles/run times to see how efficient they are at lowering the temperature of a home, (ii) how often an HVAC is on during an hour, and (iii) how fast the HVAC can get back to the correct temperature (e.g., the temperature setpoint). For example, the DERMS 104 can analyze two HVAC systems, A and B. System A can have a shorter run time but is activated more frequently throughout the day, which can indicate frequent starts and stops. System B can run for longer periods but less frequently, which can demonstrate higher efficiency in maintaining the desired temperature with fewer cycles. The DERMS 104 can determine that System B is more efficient at lowering and maintaining the home's temperature, making it a preferable choice for dispatch instructions during demand response events. In another example, System C can return faster to the set temperature after a demand response event, compared to System D. System C′s quicker recovery rate can indicate that it can effectively manage temperature adjustments without significantly impacting occupant comfort, making it more desirable for inclusion in demand response event operations.

The energy efficiency model 114 can evaluate the energy efficiency of each home by analyzing historical data on HVAC, EV chargers, and home battery storage system performance and energy consumption patterns. The analysis can consider, from various sensors, the external temperature, weather conditions, and the thermal characteristics of each home, to assess how quickly a house can be heated or cooled.

The energy efficiency model 114 can determine the optimal HVAC settings for a given demand response event. An algorithm (e.g., the energy efficiency model) can determine the optimal HVAC settings for each participating home. The energy efficiency model can learn the control duty cycles of HVAC systems necessary to maintain or achieve desired temperatures under specific conditions. It can consider the forecasted duration of the demand response event, the varying energy prices throughout the event, and the thermal inertia of each home. By adjusting temperature setpoints and duty cycles, the DERMS 104 uses the energy efficiency model output to minimize the energy used while still achieving the temperature preferences of the occupants shortly before they return home.

The energy efficiency model 114 can learn the efficiency of each HVAC system based on the duty cycles. For example, the DERMS 104 can learn that a first HVAC system takes 15 minutes to reach a desired temperature and a second HVAC system takes 60 minutes to reach that desired temperature. The timing of the duty cycle may be a useful factor. When determining whether to increase a temperature of a structure, the DERMS 104 may consider how long it will take to return to the desired temperature. The runtime of the particular HVAC system, measured by the duty cycle, gives insight to the energy efficiency model 114.

The energy efficiency model 114 may calculate an estimated runtime of an HVAC heating or cooling cycle for a target temperature. The estimated runtime may be based on the target temperature, the current indoor and outdoor conditions, and/or on a result of querying a correlation database. The correlation database may include data points for a plurality of previous HVAC heating and cooling cycles.

The energy efficiency model 114 may include calculating a cost of the estimated runtime by querying an energy rate database. The cost of the estimated runtime may be based on an identified energy rating of the HVAC system. The data points of each of the plurality of previous HVAC heating and cooling cycles may include a correlation between a monitored indoor condition, a monitored outdoor condition, a calculated indoor temperature difference, a calculated outdoor temperature difference, an HVAC cycle runtime, and/or a cost associated with one of the pluralities of previous HVAC heating and cooling cycles. The indoor/outdoor temperature differences may include a difference between an indoor/outdoor temperature and a target temperature at the time one of the pluralities of previous HVAC heating and cooling cycles is initiated.

The energy efficiency model 114 may include calculating a suggested temperature setting based on calculating the estimated runtime and calculating a cost for each of the one or more suggested target temperatures. The suggested temperature setting may include one or more suggested target temperatures. In some cases, the method may include generating a notification. The notification may include one or more of an elapsed runtime of a current HVAC cycle, a cost accumulated so far in the current HVAC cycle, an estimated remaining cost associated with the current HVAC cycle, an estimated total cost if no changes are made with the current HVAC cycle, one or more suggested target temperatures, and the cost of the one or more suggested target temperatures.

The energy efficiency model 114 may calculate a cost of an estimated runtime by querying an energy rate database, such as data stored in data repository 120. The cost of the estimated runtime may be based on an identified energy rating of the HVAC system such as an energy rating of 10 KW or 20 kW. The data points of each of the plurality of previous HVAC heating and cooling cycles may include a correlation between an indoor condition, outdoor condition, a calculated indoor temperature difference, a cycle runtime, and/or cost associated with at least one of the pluralities of previous HVAC heating and cooling cycles. The indoor temperature difference may indicate a difference between an indoor temperature and a target temperature at the time one of the pluralities of previous HVAC heating and cooling cycles is initiated. Additionally, or alternatively, the data points may include a calculated outdoor temperature difference. The outdoor temperature difference may indicate a difference between an outdoor temperature and a target temperature at the time one of the pluralities of previous HVAC heating and cooling cycles is initiated.

### Occupancy of Structures

In operation 210, the DERMS 104 can determine an occupancy state for the structure. The DERMS 104 can execute the occupancy model 110 to predict the presence or absence of residents, considering factors such as historical occupancy patterns, time of day, and even day of the week to determine the likelihood of the home being occupied at any given time. Although the occupancy model 110 is shown as a component of DERMS 104, it is intended that the occupancy model 110 or a portion of the functionality of the machine learning model 110 can be executed at the structure 130 or in a cloud configuration.

The occupancy model 110 can determine occupancy in an indoor environment (e.g., home, office, school, etc.) of the structure 130. The occupancy model 110 can utilize data from the occupancy sensors 134. The DERMS 104 can analyze and interpret various data points that can be indicative of occupancy patterns. The DERMS 104 can provide information on the occupancy state of a home, which can be useful for applications such as energy management, security, and personalized home automation. The occupancy state of the home can include “at home” “at work,” “sleeping,” “out for evening,” “regular Sunday brunch,” “on vacation,” “away short term,” “away long term,” or “multi-day absence.” In some cases, the DERMS 104 can determine occupancy information based on security data. For example, the DERMS 104 can determine a structure is occupied when the alarm for the structure is “armed” and unoccupied when the alarm for the home is “unoccupied.”

Home appliances and systems can provide data that can be utilized to predict occupancy. Home appliances and systems can include non-smart (e.g., conventional) appliances. Home appliances and security systems can include a variety of smart devices, such as thermostats, lighting systems, smart locks, cameras, EV chargers, home battery storage, and smart kitchen appliances. For example, a smart thermostat can record temperature settings and changes. A smart lock can record lock/unlock events and times. The data can include, but may not be limited to, motion detection logs, door and window access times, and the status of connected appliances. By analyzing the data, the DERMS 104 can predict or determine the presence of individuals in a home or a location within different areas of the home. For example, motion detectors can reveal movement patterns within the home, door and window sensors can indicate entries and exits, and surveillance footage can be analyzed for activity recognition. The data from home appliances and systems can include when lights are turned on or off, periods of HVAC system usage, and times when doors are locked or unlocked. The data can include binary indicators of device states (on/off, open/closed), video feeds from cameras, usage statistics from smart meters and plugs, etc. Usage statistics from smart meters and plugs can provide information regarding appliance usage patterns and overall energy consumption in real-time and historically. Environmental sensors can be used to provide data on indoor temperature, humidity levels, and air quality to indicate occupancy and the occupants' preferences for comfort settings. Information from water meters (e.g., smart water meters) and leak detectors can provide data on water usage patterns and can indicate the presence of occupants based on times of high usage. Data from kitchen devices can report times of use, duration, and functions used, which can suggest occupancy (e.g., during mealtimes). Data on the number of devices connected to the home Wi-Fi network and usage patterns can indicate the presence of occupants. Data can include timestamps and types of interactions with smart voice assistants and can indicate the presence of occupants in the home. EV charger data can indicate periods when the homeowner is likely to be at home and the vehicle is not in use. Similarly, home battery storage systems can provide data on energy consumption and surplus energy storage, which can reflect home occupancy patterns, especially during peak and off-peak hours.

Smart devices may have a WiFi interface that allows the smart device to access the Internet over a wireless local area network. The smart devices can transmit the data to a central hub or to a cloud server. The data transmitted to the cloud server can be stored and accessed by a model (e.g., machine learning model and/or other artificial intelligence model). The transmission from the central hub to the cloud can be secured through encryption and can use internet protocols like MQTT (Message Queuing Telemetry Transport) or HTTPS (Hypertext Transfer Protocol Secure).

The occupancy model 110 can identify and learn from patterns in the data. The occupancy model 110 can be trained using historical data. The occupancy model 110 can predict occupancy based on the data, learning from the daily routines and lifestyle patterns of the residents. The occupancy model 110 can digest different data types, and can include binary states, complex time-series data, timestamped records of interactions with various smart devices. For example, the data can include the on and off states of lights and HVAC systems, lock and unlock events from smart locks, usage data from appliances, thermostat temperature settings, and readings from environmental sensors.

The occupancy model 110 can be trained on a large volume of historical data. The occupancy model 110 can identify patterns and correlations that are not immediately apparent. For example, consistent lower temperatures recorded by smart thermostats, coupled with no detected motion during specific hours, can suggest that the home is unoccupied during that period. A sequence of interactions with kitchen appliances can indicate occupancy. By analyzing patterns, the occupancy model 110 can learn the normal daily routines of the home's inhabitants.

The output of the occupancy model 110 can be a probabilistic prediction or classification of occupancy status beyond basic occupancy states. The output of the occupancy model 110 can be a multi-state occupancy prediction by recognizing and categorizing more detailed scenarios, such as “at home,” “at work,” “sleeping,” “out for evening,” “regular Sunday brunch,” “on vacation,” “away short term,” “away long term,” or “multi-day absence.” The predictions can be based on real-time data compared against the learned patterns. For example, if the occupancy model 110 trained on a dataset identifies that the lights are typically turned off and the doors are locked after 10 PM, the occupancy model 110 may predict that the occupants are likely not active or possibly asleep after this time.

The occupancy model 110 can discern home occupancy patterns by analyzing temporal data and learning weekly cycles. For example, a decrease in home energy usage on weekday mornings can indicate that occupants are out for work, while a Sunday spike in energy usage in the late morning hours, followed by a period of inactivity, may suggest a habitual brunch outing. The occupancy model 110 can adjust its predictions based on variations in daily routines, recognizing that certain patterns are more likely on specific days of the week. The home occupancy assessment system can provide highly personalized and context-aware home automation services.

Various machine learning algorithms can be employed to train the occupancy model 110, including supervised learning for labeled data sets where the occupancy states are pre-defined, and unsupervised learning for detecting new patterns or anomalies in the data. The choice of machine learning algorithms can include decision trees, support vector machines, neural networks, and ensemble methods. The choice of machine learning algorithms can depend on the complexity of the patterns and the volume of the data.

The occupancy model 110 can employ unsupervised learning algorithms where no labeled ground truth data is explicitly provided. The occupancy model can identify patterns and infer occupancy states through data clustering, anomaly detection, and other methods that do not rely on predefined labels. Unsupervised learning algorithms can include clustering, association rule mining, dimensionality reduction, anomaly detection, density-based spatial clustering, and time series analysis.

The occupancy model 110 can use clustering algorithms such as k-means or hierarchical clustering to group similar data points. For example, periods of similar energy usage, sensor activity, and control settings might be clustered into different times of the day or types of occupancy states. The occupancy model 110 can discover relations between variables in large databases. For instance, if a thermostat is turned off at the same time in the morning, the model may infer a ‘morning routine’ association. The occupancy model 110 can identify outliers in the data that do not fit into any recognized patterns. The anomalies may indicate unique states like ‘on vacation’. The occupancy model 110 can analyze time-series data to identify cyclical patterns that could correspond to regular events like ‘at work’ or ‘sleeping’. As more data is collected and as occupants' habits evolve, the home occupancy assessment system, via the occupancy model 110, can employ techniques such as batch learning techniques, incremental learning, or online learning. Online learning can allow the occupancy model 110 to continuously update its parameters without the need for retraining from scratch. The occupancy model 110 can remain updated with the latest behavioral patterns, ensuring that the predictions remain accurate and relevant.

The occupancy model 110 can dynamically adapt and refine its predictions over time. As the occupancy model 110 is continuously fed new data, it can refine its understanding of occupancy patterns, adapting to changes in the residents' routines and lifestyles (e.g., using back-propagation techniques or other supervised or unsupervised learning techniques). This aspect of continuous learning can ensure that the DERMS 104 remains accurate and relevant, even as the behaviors and preferences of the occupants evolve.

When considering EV chargers, the occupancy model 110 prediction can inform the DERMS 104 of optimal times for vehicle charging. If the occupancy model 110 indicates that a homeowner is typically away during certain hours, the DERMS 104 can schedule EV charging during off-peak hours, taking advantage of lower energy rates and reduced grid demand. If the occupancy model 110 predicts that the vehicle will not be used for extended periods, such as during a ‘vacation’ status, the DERMS 104 can defer charging to times when it would be most beneficial for the grid and cost-effective for the consumer.

Home battery storage units can be reservoirs of energy that can be drawn upon when demand is high or fed into when surplus is generated. The machine learning model's occupancy prediction can allow the DERMS 104 to decide when to store energy and when to release it back into the grid. For example, if the machine learning model's occupancy prediction is a high probability of the home being unoccupied for an upcoming period, the DERMS 104 can instruct the home battery storage unit to distribute back the stored energy to the grid to meet external demands, thus preventing wasteful energy usage and contributing to grid stability.

In some embodiments, the occupancy model 110 does not use geofencing to determine occupancy. In those configurations, the occupancy model 110 utilizes motion detectors, cameras, door/window contacts, and other sensors to determine activity and presence of people and/or pets within a structure. User location based on GPS or other geofencing from a mobile device can be utilized but is not required.

In some cases, the DERMS 104 can store an occupancy schedule for the individual structures 130. The occupancy schedule can indicate time periods in which the structures 130 are scheduled to be occupied and/or unoccupied. The DERMS 104 can use data from the occupancy model 110 to generate the occupancy schedule, such as based on occupancy patterns that the occupancy model 110 identifies for the structures 130, or the occupancy schedule can be manually uploaded and/or updated by users. The occupancy model 110 can determine the occupancy of the structures 130 based on the occupancy schedule, in some cases.

### Comfort Level

When the structure is occupied, likely to be occupied, or soon to be occupied, the comfort of a user (or a pet) within the structure may be used as a factor in qualifying for an orchestration of an event. In operation 212, the DERMS 104 can use the comfort level model 112 to determine a comfort level for the structure. In assessing the comfort level needs and preferences within a home, a data-driven method can be applied by utilizing the data collected from the home's systems. Similar to the occupancy model 110 that predicts or determines occupancy, the data can be analyzed to determine a comfort score or classification, which can reflect a home occupant's tolerance to changes in their environment. For example, a comfort level model can infer comfort levels (e.g., a comfort/tolerance classification, or a comfort score) by monitoring adjustments made to a thermostat and the time elapsed before these adjustments occur after a temperature change. A method of assessing/calculating a customer's comfort preferences can be based on the following data collected from an HVAC thermostat: (i) user opt-out history, (ii) user tolerance before they opt out, (iii) how long before they opt out and/or (iv) what temperature change before the user opts out. By analyzing the user's opt-out history, the DERMS 104 can identify patterns in the frequency and conditions leading to opt-outs. The DERMS 104 can determine the user's tolerance (or comfort level) by observing how close to a temperature change the opt-out occurs, offering insights into personal comfort thresholds. Additionally, the duration before an opt-out and the extent of temperature change triggering the opt-out can allow the DERMS 104 to predict and adjust settings proactively to maintain optimal comfort without prompting user intervention.

The comfort level model 112 can generate a comfort score that can quantify an individual's sensitivity to demand response events. For example, the comfort score for DERMS 104-made thermostat (HVAC system) adjustments can be calculated using data such as temperature settings, humidity levels, and by observing how quickly a resident responds to changes in the HVAC system. By observing how quickly a resident responds to changes in these variables—such as adjusting the thermostat shortly after a temperature drift—the comfort level model 112 can infer a high sensitivity, indicated by a lower tolerance score. Conversely, a delayed or non-existent response would suggest a higher tolerance and result in a different comfort ranking.

The comfort level model 112 can classify homes with different comfort levels (e.g., high tolerance, intermediate tolerance, and low tolerance). Homes with high tolerance can be characterized by minimal occupant-made adjustments that override demand response event instructions to control the thermostat and other DERs, indicating occupants are less sensitive to fluctuations in temperature, EV charging time, etc. Low tolerance homes can be characterized by frequently exhibiting a higher frequency of adjustments to maintain a narrow comfort range, reflecting a greater sensitivity to demand response event instructions that change home conditions. Intermediate tolerance homes can be characterized by displaying occasional adjustments, suggesting a balanced sensitivity to environmental changes, where occupants are comfortable with a moderate range of changes to home conditions. This classification allows for tailored energy management strategies, ensuring that energy resources are optimally allocated to maintain desired comfort levels while considering the unique preferences and sensitivities of each household.

The comfort level model 112 can employ unsupervised machine learning algorithms to filter out false positives, which are adjustments that do not necessarily correlate with discomfort. For example, a homeowner might turn up the heat for reasons unrelated to personal comfort, such as cooking or entertaining guests. By identifying patterns that deviate from established behaviors, the comfort level model 112 can distinguish between genuine comfort-driven actions and other activities.

The comfort level model 112 can analyze patterns in environmental controls and sensor data to assess the typical needs of the homeowner. By creating a comprehensive profile of a homeowner's preferences and responses, the comfort level model 112 can predict and preemptively cause the DERMS 104 to adjust the home environment to maintain optimal comfort levels. The adjustment is especially relevant when considering individuals who may not immediately respond to discomfort, such as those engaged in focused work or sleep.

Unsupervised machine learning can be used to create comfort-adjustment schedules. By analyzing historical data, the comfort level model 112 can identify when occupants are most likely to be home and their preferred environmental settings during those times. This allows the DERMS 104 to adjust the home environment in anticipation of the occupant's arrival, ensuring they return to a comfortable setting. This kind of predictive adjustment can be fine-tuned over time as the DERMS 104 learns from ongoing occupant behavior and environmental changes. Unsupervised learning can provide the main framework for inferring comfort levels. There can be a provision for occupants to provide direct feedback on the DERMS 104's decisions (e.g., via a phone app graphical user interface). The feedback loop can refine the comfort level model to ensure that it aligns closely with the subjective comfort preferences of the occupants. As the DERMS 104 evolves, it can provide a highly personalized and adaptive living environment that continuously caters to the comfort needs of its residents with minimal human intervention.

In one example configuration, the comfort level model may detect when a thermostat is set and/or adjusted. The thermostat may be set and/or adjusted manually at a thermostat, remotely via a mobile application executing on the user device and/or by a thermostat program schedule. Upon detecting the target indoor temperature being set, the DERMS 104 may detect one or more aspects within the structure and/or outside the structure. For example, the comfort level model may receive an input of the current indoor temperature, an indoor humidity level, an outdoor temperature, an outdoor humidity level, precipitation, a level of precipitation, a type of precipitation, an atmospheric pressure, wind, a level of wind, and the like. The comfort level model may correlate the present indoor and outdoor conditions with the set target indoor temperature. Correlations between the setting of target indoor temperatures and the indoor/outdoor conditions at the time the target indoor temperatures are set may be stored in a storage device such as the data repository 120. For example, when a user sets the indoor temperature to 72° F., the DERMS 104 may record that the current indoor temperature is 74° F., the indoor humidity is 25%, the indoor air flow is negligible, the outside temperature is 85° F., the outside humidity is 30%, the precipitation level is zero, the atmospheric pressure is 1 atmosphere (atm) (i.e., 14.696 psi or 29.925 inches of mercury), that the atmospheric pressure is rising, and that the wind level is 5 miles per hour or less, etc. The system may store a correlation between these indoor/outdoor conditions and the setting of the target indoor temperature to 72° F. In some cases, the DERMS 104 may randomly or pseudo-randomly query an occupant regarding his or her comfort level. The system may correlate a response from the occupant in relation to current indoor/outdoor conditions and a current thermostat setting.

In one example configuration, the thermostats can be adjusted automatically to optimize for comfort when occupants are present and energy savings when they are not. For example, during periods of no occupancy, as indicated by the occupancy model 110, the DERMS 104 can instruct the thermostats to reduce heating or cooling, thereby lowering energy consumption and reducing strain on the grid during peak times. In anticipation of an occupant's return, based on the occupancy model 110 output data, the DERMS 104 can instruct the thermostat to adjust the home's temperature to ensure comfort upon arrival, all the while maintaining grid stability and energy efficiency. The DERMS 104 can prioritize homes with high energy efficiency for demand response events during times when energy prices are high,. By having flexibility to adjust user consumption of energy, the DERMS 104 allows for operation of a VPP or other reduction in demand at peak times.

### Virtual Power Plant System Dispatch

In operation 212, the DERMS 104 can determine the appropriate response and/or what structures 130 to dispatch for the demand response event. For example, for energy-efficient homes, the DERMS 104 may schedule demand response events during times of peak energy demand, while less efficient homes might be scheduled during off-peak hours to balance the load on the grid effectively. The DERMS 104 can consider historical data and predictive analytics to forecast the potential success of demand response events in different homes. By analyzing past participation rates and the impact of demand response events on individual home energy usage, the DERMS 104 can refine its selection criteria for future events, ensuring that the most suitable candidates are chosen for participation. The DERMS 104 can adjust energy distribution based on occupancy to ensure that energy is conserved when homes are unoccupied while maintaining comfort when residents are present. Comfort levels are assessed through individualized profiles, allowing the DERMS 104 to optimize energy settings without compromising the inhabitants' preferences.

The DERMS 104 that orchestrates dispatch of homes in a VPP during the duration of a demand response event by customizing and sending individualized dispatch instructions to homes. The DERMS 104 may do so based on an algorithm that uses data from a smart home to optimize a balance between energy price, home occupancy, and home comfort level. For example, the DERMS 104 can calculate a DR eligibility score for each structure. The DERMS 104 can calculate the DR eligibility score as a function of or based on the outputs from the occupancy model 110, the comfort level model 112, the energy efficiency model 114, and/or the pricing predictive model 116. For instance, the DERMS 104 can set a defined value for each of the structures. The DERMS 104 can adjust the defined value of each structure based on the outputs for the structures. In one example, each structure the DERMS 104 can increase the defined value for the structure if the structure is unoccupied or predicted to be unoccupied for the demand response event, decrease the value based on the structure corresponding to a low comfort level, and increase the value based on the structure corresponding to a high energy efficiency for adjustments to the DERs of the structure. The final value can be the DR eligibility score for the structure. The DERMS 104 can determine similar determinations for each structure based on the outputs of the models 110-116 to determine a DR eligibility score for each structure. The DERMS 104 can generate the DR eligibility scores using any function. The DERMS 104 may only generate instructions for the demand response event for structures with DR eligibility scores that exceed a threshold.

In some cases, the DERMS 104 may use the DR eligibility score to determine a length of time for individual structures to participate in a demand response event. For example, the DERMS 104 can determine DR eligibility scores for individual structures for different time steps of a demand response event. The DERMS 104 can do so based on outputs from the models 110-116 as described above. The DERMS 104 can compare the DR eligibility scores to the threshold and configure instructions that the DERMS 104 generates for the individual structures such that the structures only participate in the demand response event (e.g., adjust the DERs of the structures) for the time periods in which the DR eligibility scores for the structures exceed the threshold. Thus, the DERMS 104 can optimize and balance participation in the demand response event.

The DERMS 104 can operate in different modes based on whether a user desires to reduce cost, maintain comfort, or both. For example, a first state could be to maximize energy efficiency, which would reduce the energy bill for the user. A second state could be to reduce demand at peak times, such as not consuming electricity when a price is above a threshold amount. A third state could be for comfort where the user wants to ensure comfortability when present within the structure.

Orchestration factors may include geographic location/region, expected/current price of electricity in a geographical region/load zone, an energy/utility subscription plan for a structure, HVAC attributes (e.g., duty cycle and efficiency, time to return to desired temperature, whether current temperature is above/below the desired temperature and the demand response temperature), smart home data (e.g., is the structure occupied, how long will it be occupied or unoccupied), battery storage settings (e.g., predicted schedule of use, amount to drawn down, level of charge needed to participate, planned leave time, predicted/expressed usage schedule, predicted/expressed charging schedule), generator attributes (e.g., when available for use, when noise will be a factor, fuel level), user comfort tolerance, and/or allowing users to opt-in to different levels of participation (e.g., thermostat can be adjusted 1, 2, or 3 degrees).

The users can be clustered based upon their desired state as well as their energy usage. For example, using a variety of attributes, users can be grouped based on their state (e.g., reduce demand at peak times) as well as whether those users are away from the structure and a dispatch of a demand response or other DER energy consumption control can be based on capabilities of each home, device type, home efficiency, location, schedule, occupancy, and the like. When a demand response event is triggered, it may be orchestrated to issue to one or more of those clusters. Clusters (or groups) can include users who opt-in to higher tiers of demand response participation, users on vacation or away for extended periods, users known to be away from the structure based on an alarm setting, users known to be away from structure based on an analyzed/predicted schedule, and/or users in a geographic region. For example, if a substation or other power resource corresponding to the structure is experiencing heavy load or congestion, a particular demand response, based on the tier of demand response participation may be implemented for a given cluster or other granularity within the system.

The demand response dispatch can be implemented at various levels. The variations can be particular by structure, region, cluster of users, opt-in level, or other factors. The dispatch can also be implemented at different extents for different devices. In an HVAC system, the demand response can reduce duty cycle (e.g., from 5 times per hour to 3 times per hour), turn off a compressor and keep a fan on, vary the degree of change of a set temperature setting, or implement a method of precondition, pause, recondition instructions. In a structure the variation can include the EV battery charger, the demand response can stop (pause) charging or even pull energy from the battery.

The severity of an event may also determine whether a user can participate. For example, the DERMS 104 may identify an event as an emergency (or other extreme magnitude) event whereby a user cannot opt-out from participation in a demand response event. These events may be based on a situation at a power plant, a natural disaster, or other event that significantly affects capacity and/or pricing.

The optimization process can be complemented by real-time energy pricing data, allowing the DERMS 104 to make cost-effective decisions that benefit both the utility providers and the consumers. For example, during periods of high energy prices, demand response efforts can be concentrated on less energy-efficient homes or those with “intermediate” to “high tolerance” levels to ensure that energy savings are maximized without detrimentally affecting occupant comfort.

Gamification strategies can be included to encourage user participation in demand response events or other requests to reduce energy consumption. The strategies can include rewarding points for participation, which can be redeemed for discounts on electricity bills or other incentives. Leaderboards can foster a sense of community and competition, motivating homeowners to participate more actively. Gamification techniques can increase engagement and educate users about energy conservation and their impact on the grid's stability.

Gamification techniques can incentivize the users to increase their tolerance level, e.g., have a temperature (e.g., 74° F.) that is typically higher than what the user considers to be their desired comfort level (e.g., 70° F.). During times of exceptionally high demand, prices can rise dramatically. Customers participating in a demand response event may be offered a financial incentive or other reward (e.g., cryptocurrency, points that can be converted to fiat currency, prizes) to cut back their energy usage during these critical periods.

By considering occupancy, comfort levels, home energy efficiency, and energy pricing, the DERMS 104 can implement demand response events that reduce demand on the grid, reduce energy costs, and respect and adapt to the individual needs and preferences of each household. The system can optimize and determine which homes to dispatch the demand response event based on the occupancy, comfort level, energy efficiency of the home, and price of energy. Occupancy data and comfort level data can be included in the optimization process. For example, homes identified with occupants present and with a classification of ‘low tolerance’ in the comfort level model can be treated with nuanced consideration, ensuring that any demand response actions do not compromise the comfort levels of the residents. For example, during extreme weather conditions where the need for heating or cooling is paramount for occupant comfort. In another example, homes that are unoccupied or those with ‘high tolerance’ comfort levels can be targeted for more aggressive energy-saving measures, as the impact on comfort can be either minimal or non-existent.

The energy efficiency of each structure can further refine the DERMS 104's approach to dispatching demand response events. The home energy efficiency can include energy efficiency of the HVAC system and output from the energy efficiency model that can determine the optimal HVAC settings for a given demand response event. Energy-efficient structures, capable of maintaining desired temperatures with minimal energy input, can be leveraged during peak demand times to reduce the overall load on the grid.

Overall, the systems and methods described herein provide a DERMS system that orchestrates dispatch of homes of a VPP during the duration of a demand response event. The DERMS can do so by customizing and sending individualized dispatch instructions to homes based on data from a smart home relating to (1) occupancy of the home, (2) occupant comfort preference, (3) HVAC efficiency, and/or (4) Weather data. The dispatch instructions can be to control one or more than one DER. Furthermore, the DERMS system can orchestrate dispatch of homes of a VPP by selecting a subset of eligible homes based on data of the same factors.

In some cases, the DERMS system can rotate demand response participation among an aggregation of residential customers within a certain geographic area (e.g., ERCOT load zone; Transmission and Distribution Utility service area) such that the aggregation will produce the same, constant output of reduced demand (e.g., 100 MW) and customer comfort will be maximized. For instance, if an aggregation includes 10,000 customers, groups of 2,500 customers may be cycled for periods not to exceed a certain length (e.g., 15 minutes). This form of cycling could potentially decrease event opt-out rates and enable more frequent dispatching of a particular aggregation of homes/DERs.

### Example Structure

FIG. 3 illustrates an example environment 300, such as a residential property, in which at least some embodiments of the systems and methods described herein may be implemented to orchestrate a dispatch of a VPP or other energy consumption adjustment. The environment 300 may include a site that can include one or more structures, any of which can be a structure 330, such as a home, office, warehouse, garage, and/or the like. The structure 130 shown and described with reference to FIG. 1 can be the same as or similar to the structure 330. Although the environment 300 may be described in an example embodiment as a house or residence, it is intended that the environment can include any type of building or structure and can include one or more residences or may include other non-residential purposes. Further, although described as a structure or building, it is intended that the environment may be a portion of a structure or building, such as an apartment, office, or residential, commercial, industrial structure, or the like. The structure 330 may include various entryways, such as one or more doors 332, one or more windows 336, and/or a garage 360 having a garage door 362. The environment 300 may include multiple sites. In some implementations, the environment 300 includes multiple sites, each corresponding to a different property and/or building. In an example, the environment 300 may be a cul-de-sac that includes multiple structures 330.

The structure 330 may include a security system 301 or one or more security devices. The security system 301 may include a variety of hardware components and software modules or programs configured to monitor and protect the environment 300 and one or more structures 330 located thereat. In an embodiment, the security system 301 may include one or more sensors (e.g., cameras, microphones, vibration sensors, pressure sensors, motion detectors, proximity sensors (e.g., door or window sensors), range sensors, etc.), lights, speakers, and optionally one or more controllers (e.g., hub) at the structure 330 in which the security system 301 is installed. Further examples include any combination of a camera sensor, audio sensor, forced entry sensor, shock sensor, proximity sensor, boundary sensor, light beam sensor, three-dimensional (3-D) sensor, motion sensor, smoke sensor, glass break sensor, door sensor, window sensor, carbon monoxide sensor, accelerometer, global positioning system (GPS) sensor, Wi-Fi positioning system sensor, capacitance sensor, radio frequency sensor, near-field sensor, temperature sensor, humidity sensor, airflow sensor, atmospheric pressure sensor, precipitation sensor, cloud cover sensor, heartbeat sensor, breathing sensor, oxygen sensor, carbon dioxide sensor, brain wave sensor, movement sensor, voice sensor, other types of sensors, actuators, or combinations thereof. In an embodiment, the cameras, sensors, lights, speakers, and/or other devices may be smart by including one or more processors therewith to be able to process sensed information (e.g., images, sounds, motion, etc.) so that decisions may be made by the processor(s) as to whether the captured information is associated with a security risk or otherwise.

A first camera 310a and a second camera 310b, referred to herein collectively as cameras 310, may be disposed at the environment 300, such as outside and/or inside the structure 330. The cameras 310 may be attached to the structure 330, such as at a front door of the structure 330 or inside of a living room. The cameras 310 may communicate with each other over a local network 305. The cameras 310 may communicate with a server 320 over a network 302. The local network 305 and/or the network 302, in some implementations, may each include a digital communication network that transmits digital communications. The local network 305 and/or the network 302 may each include a wireless network, such as a wireless cellular network, a local wireless network, such as a Wi-Fi network, a Bluetooth® network, a near-field communication (“NFC”) network, an ad hoc network, and/or the like. The local network 305 and/or the network 302 may each include a wide area network (“WAN”), a storage area network (“SAN”), a local area network (“LAN”) (e.g., a home network), an optical fiber network, the internet, or other digital communication network. The local network 305 and/or the network 302 may each include two or more networks. The network 302 may include one or more servers, routers, switches, and/or other networking equipment. The local network 305 and/or the network 302 may also include one or more computer readable storage media, such as a hard disk drive, an optical drive, non-volatile memory, RAM, or the like.

The local network 305 and/or the network 302 may be a mobile telephone network. The local network 305 and/or the network 302 may employ a Wi-Fi network based on any one of the Institute of Electrical and Electronics Engineers (“IEEE”) 802.11 standards. The local network 305 and/or the network 302 may employ Bluetooth® connectivity and may include one or more Bluetooth connections. The local network 305 and/or the network 302 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 305 and/or the network 302 may employ ZigBee® connectivity based on the IEEE 802 standard and may include one or more ZigBee connections. The local network 305 and/or the network 302 may include a ZigBee® bridge. In some implementations, the local network 305 and/or the network 302 employs Z-Wave® connectivity as designed by Sigma Designs@ and may include one or more Z-Wave connections. The local network 305 and/or the network 302 may employ an ANT® and/or ANT+® connectivity as defined by Dynastream® Innovations Inc. of Cochrane, Canada and may include one or more ANT connections and/or ANT+ connections.

The first camera 310a may include an image sensor 315a, a processor 311a, a memory 312a, a depth sensor 314a (e.g., radar sensor 314a), a speaker 316a, and a microphone 318a. The memory 312a may include computer-readable, non-transitory instructions which, when executed by the processor 311a, cause the processor 311a to perform methods and operations discussed herein. The processor 311a may include one or more processors. The second camera 310b may include an image sensor 315b, a processor 311b, a memory 312b, a radar sensor 314b, a speaker 316b, and a microphone 318b. The memory 312b may include computer-readable, non-transitory instructions which, when executed by the processor 311b, cause the processor to perform methods and operations discussed herein. The processor 311a may include one or more processors.

The memory 312a may include an AI model 313a. The AI model 313a may be applied to or otherwise process data from the camera 310a, the radar sensor 314a, and/or the microphone 318a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 310 may determine a likelihood that an object 370, such as a package, vehicle, person, or animal, is within an area (e.g., a geographic area, a property, a room, a field of view of the first camera 310a, a field of view of the second camera 310b, a field of view of another sensor, or the like) based on data from the first camera 310a, the second camera 310b, and/or other sensors.

The memory 312b of the second camera 310b may include an AI model 313b. The AI model 313b may be similar to the AI model 313a. In some implementations, the AI model 313a and the AI model 313b have the same parameters. In some implementations, the AI model 313a and the AI model 313b are trained together using data from the cameras 310. In some implementations, the AI model 313a and the AI model 313b are initially the same but are independently trained by the first camera 310a and the second camera 310b, respectively. For example, the first camera 310a may be focused on a porch and the second camera 310b may be focused on a driveway, causing data collected by the first camera 310a and the second camera 310b to be different, leading to different training inputs for the first AI model 313a and the second AI model 313b. In some implementations, the AI models 313 are trained using data from the server 320. In an example, the AI models 313 are trained using data collected from a plurality of cameras associated with a plurality of buildings. The cameras 310 may share data with the server 320 for training the AI models 313 and/or a plurality of other AI models. The AI models 313 may be trained using both data from the server 320 and data from their respective cameras.

The cameras 310, in some implementations, may determine a likelihood that the object 370 (e.g., a package) is within an area (e.g., a portion of a site or of the environment 300) based at least in part on audio data from microphones 318, using sound analytics and/or the AI models 313. In some implementations, the cameras 310 may determine a likelihood that the object 370 is within an area based at least in part on image data using image processing, image detection, and/or the AI models 313. The cameras 310 may determine a likelihood that an object is within an area based at least in part on depth data from the radar sensors 314, a direct or indirect time of flight sensor, an infrared sensor, a structured light sensor, or other sensor. For example, the cameras 310 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 314.

The sensors, such as cameras 310, radar sensors 314, microphones 318, door sensors, window sensors, or other sensors, may be configured to determine occupancy. For example, the microphones 318 may be configured to sense sounds, such as voices, broken glass, door knocking, or otherwise, and an audio processing system may be configured to process the audio so as to determine whether the captured audio signals are indicative of the presence of a person in the environment 300 or structure 330.

A user interface 319 may be installed or otherwise located at the structure 330. The user interface 319 may be part of or executed by a device, such as a mobile phone, a tablet, a laptop, wall panel, or other device. The user interface 319 may connect to the cameras 310 via the network 302 or the local network 305. The user interface 319 may allow a user to access sensor data of the cameras 310. In an example, the user interface 319 may allow the user to view a field of view of the image sensors 315 and hear audio data from the microphones 318. In an example, the user interface may allow the user to view a representation, such as a point cloud, of radar data from the radar sensors 314.

The user interface 319 may allow a user to provide input to the cameras 310. In an example, the user interface 319 may allow a user to speak or otherwise provide sounds using the speakers 316. One example of the user interface 319 may include an interface of the user device 140 of FIG. 1. Other examples of the user interface 319 may include other implementations of user interfaces being mobile, fixed, personal, public, etc.

In some implementations, the cameras 310 may receive additional data from one or more additional sensors, such as a door sensor 335 of the door 332, an electronic lock 333 of the door 332, a doorbell camera 334, and/or a window sensor 339 of the window 336. The door sensor 335, the electronic lock 333, the doorbell camera 334 and/or the window sensor 339 may be connected to the local network 305 and/or the network 302. The cameras 310 may receive the additional data from the door sensor 335, the electronic lock 333, the doorbell camera 334 and/or the window sensor 339 from the server 320.

In some implementations, the cameras 310 may determine separate and/or independent likelihoods that an object is within an area based on data from different sensors (e.g., processing data separately, using separate machine learning and/or other artificial intelligence, using separate metrics, or the like). The cameras 310 may combine data, likelihoods, determinations, or the like from multiple sensors such as image sensors 315, the radar sensors 314, and/or the microphones 318 into a single determination of whether an object is within an area (e.g., in order to perform an action relative to the object 370 within the area. For example, the cameras 310 and/or each of the cameras 310 may use a voting algorithm and determine that the object 370 is present within an area in response to a majority of sensors of the cameras and/or of each of the cameras determining that the object 370 is present within the area. In some implementations, the cameras 310 may determine that the object 370 is present within an area in response to all sensors determining that the object 370 is present within the area (e.g., a more conservative and/or less aggressive determination than a voting algorithm). In some implementations, the cameras 310 may determine that the object 370 is present within an area in response to at least one sensor determining that the object 370 is present within the area (e.g., a less conservative and/or more aggressive determination than a voting algorithm).

The cameras 310, in some implementations, may combine confidence metrics indicating likelihoods that the object 370 is within an area from multiple sensors of the cameras 310 and/or additional sensors (e.g., averaging confidence metrics, selecting a median confidence metric, or the like) in order to determine whether the combination indicates a presence of the object 370 within the area. In some embodiments, the cameras 310 are configured to correlate and/or analyze data from multiple sensors together. For example, the cameras 310 may detect a person or other object in a specific area and/or field of view of the image sensors 315 and may confirm a presence of the person or other object using data from additional sensors of the cameras 310 such as the radar sensors 314 and/or the microphones 318, confirming a sound made by the person or other object, a distance and/or speed of the person or other object, or the like. The cameras 310, in some implementations, may detect the object 370 with one sensor and identify and/or confirm an identity of the object 370 using a different sensor. In an example, the cameras detect the object 370 using the image sensor 315a of the first camera 310a and verifies the object 370 using the radar sensor 314b of the second camera 310b. In this manner, in some implementations, the cameras 310 may detect and/or identify the object 370 more accurately using multiple sensors than may be possible using data from a single sensor.

The cameras 310, in some implementations, in response to determining that a combination of data and/or determinations from the multiple sensors indicates a presence of the object 370 within an area, may perform, initiate, or otherwise coordinate one or more actions relative to the object 370 within the area. For example, the cameras 310 may perform an action including emitting one or more sounds from the speakers 316, turning on a light, turning off a light, directing a lighting element toward the object 370, opening or closing the garage door 362, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 310 may actuate an interior light 337 of the structure 330 and/or an exterior light 338 of the structure 330. The interior light 337 and/or the exterior light 338 may be connected to the local network 305 and/or the network 302.

In some implementations, the cameras 310 may monitor one or more objects based on a combination of data and/or determinations from the multiple sensors. For example, in some embodiments, the cameras 310 may detect and/or determine that a detected human has picked up the object 370 (e.g., a package, a bicycle, a mobile phone or other electronic device, or the like) and is walking or otherwise moving away from the home or other structure 330. In a further embodiment, the cameras 310 may monitor a vehicle, such as an automobile, a boat, a bicycle, a motorcycle, an offroad and/or utility vehicle, a recreational vehicle, or the like. The cameras 310, in various embodiments, may determine if a vehicle has been left running, if a door has been left open, when a vehicle arrives and/or leaves, or the like.

The environment 300 may include one or more regions of interest, which each may be a given area within the environment. A region of interest may include the entire environment 300, an entire site within the environment, or an area within the environment. A region of interest may be within a single site or multiple sites. A region of interest may be inside of another region of interest. In an example, a property-scale region of interest which encompasses an entire property within the environment 300 may include multiple additional regions of interest within the property.

The environment 300 may include a first region of interest 340 and/or a second region of interest 350. The first region of interest 340 and the second region of interest 350 may be determined by the AI models 313, fields of view of the image sensors 315 of the cameras 310, fields of view of the radar sensors 314, and/or user input received via the user interface 319. In an example, the first region of interest 340 includes a garden or other landscaping of the structure 330 and the second region of interest 350 includes a driveway of the structure 330. In some implementations, the first region of interest 340 may be determined by user input received via the user interface 319 indicating that the garden should be a region of interest and the AI models 313 determining where in the fields of view of the sensors of the cameras 310 the garden is located. In some implementations, the first region of interest 340 may be determined by user input selecting, within the fields of view of the sensors of the cameras 310 on the user interface 319, where the garden is located. Similarly, the second region of interest 350 may be determined by user input indicating, on the user interface 319, that the driveway should be a region of interest and the AI models 313 determining where in the fields of view of the sensors of the cameras 310 the driveway is located. In some implementations, the second region of interest 350 may be determined by user input selecting, on the user interface 319, within the fields of view of the sensors of the cameras 310, where the driveway is located.

In a further embodiment, the cameras 310 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door, lighting a fireplace, powering an electrical outlet, turning on or play a predefined channel or video or music on a television or other device, starting or stopping a kitchen appliance, starting or stopping a sprinkler system, opening or closing a garage door 303, adjusting a temperature or other function of a thermostat or furnace or air conditioning unit, or the like. In response to detecting a presence of a known human, one or more safe behaviors and/or conditions, or the like, in some embodiments, the cameras 310 may extend, increase, pause, toll, and/or otherwise adjust a waiting/monitoring period after detecting a human, before performing a deter action, or the like.

In some implementations, the cameras 310 may receive a notification from a user's smart phone that the user is within a predefined proximity or distance from the home, e.g., on their way home from work. Accordingly, the cameras 310 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 310, in some implementations, may be configured to detect one or more health events based on data from one or more sensors. For example, the cameras 310 may use data from the radar sensors 314 to determine a heartrate, a breathing pattern, or the like and/or to detect a sudden loss of a heartbeat, breathing, or other change in a life sign. The cameras 310 may detect that a human has fallen and/or that another accident has occurred.

In some embodiments, the security system 301 and/or one or more security devices may include one or more speakers 316. The speaker(s) 316 may be independent from other devices or integrated therein. For example, the camera(s) may include one or more speakers 316 (e.g., speakers 316a, 316b) that enable sound to be output therefrom. In an embodiment, a controller or other device may include a speaker from which sound (e.g., alarm sound, tones, verbal audio, and/or otherwise) may be output. The controller may be configured to cause audio sounds (e.g., verbal commands, dog barks, alarm sounds, etc.) to play and/or otherwise emit audio from the speaker(s) 316 located at the structure 330. In an embodiment, one or more sounds may be output in response to detecting the presence of a human within an area.

In some implementations, the cameras 310 and/or the server 320 (or other device), may include image processing capabilities and/or radar data processing capabilities for analyzing images, videos, and/or radar data that are captured with the cameras 310. The image/radar processing capabilities may include object detection, facial recognition, gait detection, and/or the like. For example, the controller 306 may analyze or process images and/or radar data to determine that a package is being delivered at the front door/porch. In other examples, the cameras 310 may analyze or process images and/or radar data to detect a child walking within a proximity of a pool, to detect a person within a proximity of a vehicle, to detect a mail delivery person, to detect animals, and/or the like. In some implementations, the cameras 310 may utilize the Al models 313 for processing and analyzing image and/or radar data.

In some implementations, the security system 301 and/or the one or more security devices are connected to various IoT devices. As used herein, an IoT device may be a device that includes computing hardware to connect to a data network and to communicate with other devices to exchange information. In such an embodiment, the cameras 310 may be configured to connect to, control (e.g., send instructions or commands), and/or share information with different IoT devices. Examples of IoT devices may include home appliances (e.g., stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 310 may poll, request, receive, or the like information from the IoT devices (e.g., status information, health information, power information, and/or the like) and present the information on a display and/or via a mobile application.

The IoT devices may include a smart home device 331. The smart home device 331 may be connected to the IoT devices. The smart home device 331 may receive information from the IoT devices, configure the IoT devices, and/or control the IoT devices. In some implementations, the smart home device 331 provides the cameras 310 with a connection to the IoT devices. In some implementations, the cameras 310 provide the smart home device 331 with a connection to the IoT devices. The smart home device 331 may be an AMAZON ALEXA device, an AMAZON ECHO device, A GOOGLE NEST device, a GOOGLE HOME device, or other smart home hub or device. In some implementations, the smart home device 331 may receive commands, such as voice commands, and relay the commands to the cameras 310. In some implementations, the cameras 310 may cause the smart home device 331 to emit sound and/or light, speak words, or otherwise notify a user of one or more conditions via the user interface 319.

In some implementations, the IoT devices include various lighting components including the interior light 337, the exterior light 338, the smart home device 331, other smart light fixtures or bulbs, smart switches, and/or smart outlets. For example, the cameras 310 may be communicatively connected to the interior light 337 and/or the exterior light 338 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 331.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of this disclosure or the claims.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc., can be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein can be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system comprising:
one or more processors configured by computer-readable instruction to:
determine a need for a change in energy consumption at one or more structures based upon energy pricing or energy availability data;
responsive to detecting an increase in energy pricing or a decrease in energy capacity, execute an occupancy model configured to receive sensor data from a structure of the one or more structures and output a state of occupancy for the structure;
generate a demand response event instruction indicating an energy adjustment for at least one distributed energy resource (DER) of the structure based at least on the state of occupancy for the structure; and
transmit the demand response event instruction to the structure.

2. The system according to claim 1, wherein the one or more processors are further configured to execute a comfort level model configured to measure a variation of operation of the at least one DER from a user's setting of the at least one DER.

3. The system according to claim 1, wherein the one or more processors are configured to generate the demand response event instruction based further on a variation of operation of the at least one DER.

4. The system according to claim 1, wherein the one or more processors are further configured to execute an energy efficiency model configured to measure efficiency of the at least one DER at the structure.

5. The system according to claim 4, wherein the one or more processors are configured to generate the demand response event instruction based further on the efficiency of the at least one DER.

6. The system according to claim 1, wherein the at least one DER comprises an HVAC system, a battery, or an electric vehicle charger.

7. The system according to claim 1, wherein the one or more processors are configured to select a plurality of structures of the one or more structures for the energy adjustment based on the need based on occupancy data of the plurality of structures.

8. The system according to claim 1, wherein the one or more processors are configured to select a plurality of structures of the one or more structures for the energy adjustment based on the need based on the occupancy of the plurality of structures, a comfort level of the plurality of structures, and an energy efficiency of the plurality of structures.

9. A method comprising:
detecting, by at least one processor, an increase in energy pricing or a decrease in energy capacity;
generating, by the at least one processor, a demand response event instruction;
identifying, by the at least one processor, which subset of a plurality of structures qualifies for the demand response event instruction, wherein the identifying comprises determining an occupancy state for each structure; and
transmitting, by the at least one processor, the demand response event instruction to the subset of structures that qualify.

10. The method of claim 9, wherein the determining the occupancy state for each structure comprises executing, by the at least one processor, an occupancy machine learning model configured to receive sensor data from the structure and output a state of occupancy for the structure.

11. The method of claim 9, wherein the identifying further comprises determining an energy efficiency of each structure.

12. The method of claim 11, wherein the determining the energy efficiency for each structure comprises executing, by the at least one processor, an occupancy machine learning model configured to receive distributed energy resource (DER) data from the structure and measure efficiency of the at least one DER at the structure.

13. The method of claim 9, wherein the identifying further comprises determining a comfort level of each structure.

14. The method of claim 9, wherein identifying, by the at least one processor, which subset of a plurality of structures qualifies for the demand response event instruction comprises executing, by the at least one processor, an occupancy machine learning model configured to measure a variation of operation of at least one distributed energy resource (DER) from a user's setting of the at least one DER.

15. The method of claim 9, wherein the demand response event instruction adjusts energy consumption by a distributed energy resource (DER) of the structure.

16. The method of claim 15, wherein the DER comprises an HVAC system, a battery, or an electric vehicle charger.

17. A method comprising:
detecting, by at least one processor, an increase in energy pricing or a decrease in energy capacity;
generating, by the at least one processor, a request for an energy consumption adjustment based on the energy pricing or energy capacity;
identifying, by the at least one processor, which subset of structures of a plurality of structures qualifies for the energy consumption adjustment, wherein the identifying comprises determining an occupancy state for each structure;
generating and transmitting, by the at least one processor, a notification to the subset of a plurality of structures requesting participation in the energy consumption adjustment;
upon receiving a response from a structure of the of the plurality of structures to participate, transmitting, by the at least one processor, an instruction to the subset of structures for the energy consumption adjustment; and
upon detecting an implementation of the energy consumption adjustment by each structure, automatically allocating, by the at least one processor, a reward to an account for each of the subset of structures.

18. The method of claim 17, wherein the determining the occupancy state for each structure comprises executing, by the at least one processor, an occupancy machine learning model configured to receive sensor data from the structure and output a state of occupancy for the structure.

19. The method of claim 17, wherein the identifying further comprises determining an energy efficiency of each structure.

20. The method of claim 19, wherein the determining the energy efficiency for each structure comprises executing, by the at least one processor, an occupancy machine learning model configured to receive distributed energy resource (DER) data from the structure and measure efficiency of the at least one DER at the structure.

21. The method of claim 17, wherein the identifying further comprises determining a comfort level of each structure.

22. The method of claim 21, wherein the determining the comfort level for each structure comprises executing, by the at least one processor, an occupancy machine learning model configured to measure a variation of operation of at least one distributed energy resource (DER) from a user's setting of the at least one DER.

23. The method of claim 17, wherein the energy consumption adjustment adjusts energy consumption by a distributed energy resource (DER) of the structure.

24. The method of claim 23, wherein the DER comprises an HVAC system, a battery, or an electric vehicle charger.
